(19) United States
(12) Patent Application Publication
(10) Pub. No.: US 2026/0148474 A1
(43) Pub. Date: May 28, 2026

(54) GENERATIVE THREE-DIMENSIONAL (3D) DIGITAL HUMAN FOUNDATION MODEL FROM IN THE WILD TWO-DIMENSIONAL (2D) IMAGES

(71) Applicant: NVIDIA Corporation, Santa Clara, CA (US)

(72) Inventors: Koki Nagano, Playa Vista, CA (US); Jingxiang Sun, Santa Clara, CA (US); Shalini De Mello, San Francisco, CA (US); Ye Yuan, Santa Clara, CA (US); Umar Iqbal, Santa Clara, CA (US); Tianye Li, Cupertino, CA (US); Xueting Li, Sunnyvale, CA (US)

(21) Appl. No.: 19/340,009

(22) Filed: Sep. 25, 2025

Related U.S. Application Data
(60) Provisional application No. 63/726,101, filed on Nov. 27, 2024.
(60) Provisional application No. 63/764,129, filed on Feb. 27, 2025.

(51) Int. Cl. G06T 15/04; G06T 7/246; G06T 13/40; G06V 10/764; G06V 10/774; G06V 10/776; G06V 10/82; G06V 40/16

(52) U.S. Cl. CPC G06T 15/04; G06T 7/248; G06T 7/251; G06T 13/40; G06V 10/764; G06V 10/7747; G06V 10/776; G06V 10/82; G06T 2200/24; G06T 2207/20081; G06T 2207/20084; G06T 2207/30201; G06V 40/174

(57) ABSTRACT

Systems and methods are disclosed for training and using a digital human foundational model (DHFM) comprising a generative adversarial network (GAN) generator. For instance, the method may include obtaining one or more inputs comprising pose information indicating a three-dimensional (3D) pose representation of a human and processing the one or more inputs using a mapping network to generate intermediate latent code. The method may further include processing the intermediate latent code using the trained generator to generate texel-aligned Gaussian maps that align Gaussian attributes to a coarse mesh template of the human and performing linear blend skinning and deformation on the texel-aligned Gaussian maps to obtain modified texel-aligned Gaussian maps. The method may also include processing the modified texel-aligned Gaussian maps using a multi-part renderer to generate a synthetic human representation of the human indicating facial and hand features of the human.

### CLAIM OF PRIORITY

This application claims the benefit of U.S. Provisional Application No. 63/726,101 (Attorney Docket No. 515197) titled “GENERATIVE 3D DIGITAL HUMAN FOUNDATION MODEL FROM IN THE WILD 2D IMAGES,” filed Nov. 27, 2024 and U.S. Provisional Application No. 63/764,129 (Attorney Docket No. 515290) titled “GENERATIVE 3D DIGITAL HUMAN FOUNDATION MODEL FROM IN THE WILD 2D IMAGES,” filed Feb. 27, 2025, the entire contents of which are incorporated herein by reference.

### BACKGROUND

Digital humans (DH) technology may be used in a myriad of applications including movies, games, and extended reality (XR). While having vast potential, conventional DH technology remains inefficient and challenging to scale due to their models being trained on small, domain-focused datasets. For instance, to address each application, conventional approaches train separate task-specific models with small-targeted datasets (e.g., a small dataset for hair, another for face, and yet another for body), which lead to domain-specific models with limited capabilities and generalization that are combined together to form the DH technology. In addition, although both gaming asset generation and three-dimensional (3D) telepresence create human heads, their distinct training methods (e.g., 3D scans versus red, green, blue (RGB) video) hinder reusability and lead to fragmented, bottom-up solutions. This fragmentation curbs capabilities when data is scarce, introduces ad hoc integration challenges, and limits the scaling of digital human practices. In other words, while many DH tasks are to be performed together, conventional approaches include multiple incongruent models that are utilized together to complete the task. However, ad-hoc integration of incorporating multiple incongruent models may create challenges. For example, a first model that is trained using a small dataset for hair may cause problems when combined with a second model that is trained with another small dataset for facial features (e.g., it may become difficult to combine and efficiently utilize the outputs of the first and second models given that during training, such a scenario might not have been actively considered). As such, training separate models that are combined together to form the DH technology is highly inefficient and is not scalable. Accordingly, there is a need for addressing these issues and/or other issues associated with the prior art.

### SUMMARY

Embodiments of the present disclosure relate to a generative 3D digital human foundation model that is trained from in the wild 2D images. For instance, systems and methods are disclosed that present a unified and highly-scalable “unconditional” generative digital human foundational model (DFHM) for photorealistic and animatable 3D full-body synthesis. The DFHM may be trained on a large collection of in-the-wild 2D photos, which may enable a wide range of downstream applications. Specifically, in terms of DH generative models, there exists conventional approaches that create statistical 3D human representations for faces, which has significantly moved the field forward. However, these existing approaches use a mesh-based representation and focus mostly on coarse geometric shapes and do not model photorealistic appearance or complex geometry (e.g., deforming clothing or hair). They also require expensive multi-view capture setups to acquire training data, which does not scale well to a large diversity of subjects and environments and requires significant manual effort for data preprocessing. To circumvent this, a family of 3D-aware generative adversarial networks (GANs) were presented that learns to create photorealistic 3D human heads from a collection of in-the-wild 2D photos, but they either lack human animation control and/or do not scale to creating full-body humans. While some efforts have attempted to address 3D full-body generative models from in-the-wild images, they still face challenges in producing photorealistic results and struggle to scale to large datasets. These limitations arise from the inherent inefficiencies of existing 3D representations, which make it difficult to achieve both high detail and efficient rendering, as well as the challenges of collecting large-scale, high-fidelity datasets.

In contrast to conventional systems, such as those described above, embodiments of the present disclosure describe a foundational model for digital humans (e.g., the DHFM) that uses 3D Gaussian Splatting (3DGS), and the foundational model may be trained on large-scale two-dimensional (2D) in-the-wild data (e.g., a large collection of in-the-wild 2D photos/images). In some examples, the DHFM may be configured to perform photorealistic and animatable 3D full-body synthesis, which may be usable for a wide range of downstream applications. Furthermore, the DHFM may be capable of generating photorealistic 3D avatars without utilizing multi-view capture.

In an embodiment, a computer-implemented method for training a digital human foundational model (DHFM) comprising a generative adversarial network (GAN) generator is provided. The method includes obtaining training inputs comprising pose information that is sampled from a training dataset, and the pose information indicates a three-dimensional (3D) pose representation of a human. The method further includes processing the training inputs using the GAN generator to generate texel-aligned Gaussian maps that align Gaussian attributes to a coarse mesh template of the human and rendering a synthetic human representation of the human based on the texel-aligned Gaussian maps. The synthetic human representation comprises a full-bodied representation of the human indicating facial and hand features of the human. The method also includes processing the synthetic human representation using one or more discriminators to generate one or more discriminator outputs, computing one or more losses based on the texel-aligned Gaussian maps and the one or more discriminator outputs, and training the GAN generator using the one or more losses.

In another embodiment, a computer-implemented method for using a digital human foundational model (DHFM) comprising a generative adversarial network (GAN) generator is provided. The method includes obtaining one or more inputs comprising pose information indicating a three-dimensional (3D) pose representation of a human and processing the one or more inputs using a mapping network to generate intermediate latent code. The method also includes processing the intermediate latent code using the trained generator to generate texel-aligned Gaussian maps that align Gaussian attributes to a coarse mesh template of the human and performing linear blend skinning and deformation on the texel-aligned Gaussian maps to obtain modified texel-aligned Gaussian maps. The method further includes processing the modified texel-aligned Gaussian maps using a multi-part renderer to generate a synthetic human representation of the human indicating facial and hand features of the human.

In yet another embodiment, a computer-implemented method for generating and curating a training dataset for training one or more machine learning—artificial intelligence (ML-AI) models is provided. The method includes extracting, using a two-dimensional (2D) extraction algorithm, 2D landmarks of a human from an obtained image that is within the training dataset and extracting, using a three-dimensional (3D) pose estimator, 3D poses of the human from the obtained image. The method also includes using camera coordinates associated with the obtained image to project the 3D poses of the human into 2D space, fine-tuning the 3D poses of the human based on comparing the projected 3D poses in 2D space with the extracted 2D landmarks, and generating labels for the obtained image within the training dataset. The labels comprise the 2D landmarks and the fine-tuned 3D poses of the human. The method further includes augmenting the training dataset with a plurality of generated synthetic images of humans and training the one or more ML-AI models based on the labels, the obtained image, and the plurality of generated synthetic images.

### BRIEF DESCRIPTION OF THE DRAWINGS

The present systems and methods for training and using a generative 3D digital human foundation model from in the wild 2D images are described in detail below with reference to the attached drawing figures, wherein:

FIG. 1A shows a training process for training a foundational model (e.g., the DHFM), in accordance with one or more embodiments of the present disclosure.

FIG. 1B shows a synthetic human representation generation process that uses the DHFM to generate synthetic human representations, in accordance with one or more embodiments of the present disclosure.

FIG. 2A shows a one-shot training process for one-shot generation of 3D synthetic human representations, in accordance with one or more embodiments of the present disclosure.

FIG. 2B shows an intermediate latent space interpolation process, in accordance with one or more embodiments of the present disclosure.

FIG. 2C shows an appearance editing process that uses the DHFM to generate synthetic human representations, in accordance with one or more embodiments of the present disclosure.

FIG. 3A illustrates a flowchart of a method for training a digital human foundational model (DHFM) comprising a generative adversarial network (GAN) generator, in accordance with one or more embodiments of the present disclosure.

FIG. 3B illustrates a flowchart of a method for using a digital human foundational model (DHFM) comprising a generative adversarial network (GAN) generator, in accordance with one or more embodiments of the present disclosure.

FIG. 4 is a conceptual diagram of a processing system implemented using a parallel processing unit (PPU), suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

FIGS. 7A and 7B show a data curation process to generate the large-scale “in-the-wild” training dataset, in accordance with one or more embodiments of the present disclosure.

FIG. 8 illustrates a flowchart of a method for generating and curating a training dataset for training one or more machine learning—artificial intelligence (ML-AI) models, in accordance with one or more embodiments of the present disclosure.

### DETAILED DESCRIPTION

Embodiments of the present disclosure relate to a generative 3D digital human foundation model that is trained from in the wild 2D images. For instance, systems and methods are disclosed that present a unified and highly-scalable “unconditional” generative digital human foundational model (DFHM) for photorealistic and animatable 3D full-body synthesis. Specifically, embodiments of the present disclosure may adopt 3D Gaussian Splatting (3DGS) as the core 3D representation due to its efficient rendering and expressive capacity. To address the unstructured nature of Gaussian-based representations, embodiments of the present disclosure may rig the Gaussian points of a human-body mesh template, which may provide a coherent reference for articulations. This may enforce a structured topology on the Gaussians, allowing the model to handle complex poses and occlusions effectively. Embodiments of the present disclosure may then leverage a generative adversarial network (GAN) to generate texel-aligned Gaussian maps. By conditioning the 3D-aware GAN generator and discriminator on coarse body pose priors and viewpoints, embodiments of the present disclosure may ensure both 3D-aware learning of full-body shape and high-fidelity alignment to the training data's appearance distribution. Further, embodiments of the present disclosure may introduce body-part generation and discrimination, along with carefully designed regularization techniques, to further improve geometric and visual fidelity.

To train the DFHM, embodiments of the present disclosure may additionally curate, the largest of its kind, in-the-wild dataset comprising millions of high-quality 2D images of full-body humans. The dataset features may allow for significant diversity in terms of human attributes, including body pose, camera viewpoint, race, age, gender, headgear, hairstyles, clothing and lighting. The dataset may carefully select or synthesize high-quality and high-resolution photos of full-body humans captured in the wild, which may be sourced via replicable automated processes. Embodiments of the present disclosure may further annotate the dataset with diverse high-quality labels, including person segmentation and matting information, 2D body keypoints and/or 3D body pose.

On standard benchmark datasets, it was shown that the DHFM architecture achieves the state of the art in terms of quality and efficiency, surpassing all existing conventional approaches. Additionally, when combined with the novel large-scale high-quality full-body human dataset, the DHFM further achieves unprecedented quality and generalization for 3D digital human generation. In addition, embodiments of the present disclosure also may enable many downstream applications including, high-fidelity DH 3D asset generation from casual inputs, their texture editing and animation with a provided motion sequence, and/or conditional image-to-3D lifting of humans from provided sparse input views.

As will be described in further detail below, embodiments of the present disclosure describe a highly scalable digital human foundation model for photoreal and animatable 3D full-body synthesis via generative texel-aligned Gaussian maps and carefully designed regularization. In addition, embodiments of the present disclosure curate the largest of its kind diverse dataset of millions of high-quality in-the-wild 2D photos of full-body humans containing many high-quality annotations to train the DHFM model. Further, it was shown that the DFHM achieves state-of-the-art quality, efficiency and generalization, and successfully enables many different downstream applications, including unconditional high-quality 3D asset creation, animation, texture editing and sparse image-to-3D lifting.

Prior to describing the DHFM in detail, 3DGS is initially described. For instance, 3DGS may be configured to represent 3D scenes using 3D Gaussian primitives, and images may be rendered from the 3D Gaussian primitives using elliptical weighted average (EWA) volume splatting. For example, each Gaussian primitive may be explicitly parameterized by five different attributes: the Gaussian center, scale, rotation parameterized by a quaternion, color, and opacity. To render an image, the 3D Gaussians are splatted onto 2D planes, resulting in 2D Gaussians. The pixel color for each pixel may be computed based on blending the 2D Gaussians that overlap the pixel. This is described in further detail in Kerbel et al. 2023, “3d gaussian splatting for real-time radiance field rendering.” In: ACM Trans. Graph. 42, 4 (2023) (“Kerbel”), which is incorporated by reference herein in its entirety.

In other words, the previous approach described by Kerbel proposes to represent 3D scenes with 3D Gaussian primitives and render images using elliptical weighted average (EWA) volume splatting. Each 3D Gaussian primitive [symbol] (x) is explicitly parameterized by five different attributes: the Gaussian center μ∈ [symbol] , scale s ∈ [symbol] , rotation parameterized as a quaternion q∈ [symbol] , color c∈ [symbol] , and opacity σ∈ [symbol] :

$$𝒢 ( x ) = exp ( - \frac{1}{2} {( x - μ )}^{T} {\sum }^{- 1} ( x - μ ) )$$

where the covariance matrix Σ=RSS^{T}R^{T} is factorized into a scaling matrix S and a rotation matrix R given by the quaternions q and scaling s. To render an image, the 3D Gaussians are splatted onto 2D planes, resulting in 2D Gaussians. The pixel color C is computed by blending N ordered 2D Gaussians overlapping this pixel:

$$c = {{\sum }^{N}}_{i = 1} {α}_{i} {c}_{i} {\prod }_{j = 1}^{i - 1} ( 1 - {α}_{j} )$$

where cᵢ is the color of each 2D Gaussian, and a is the blending weight derived from the 2D projection of the 3D Gaussian multiplied by a per-Gaussian opacity o.

However, while conventional 3DGS processes (e.g., Kerbel) optimize the attributes of the 3D Gaussian primitives using a photometric loss, which enables high-fidelity reconstruction of static scenes, adapting a 3DGS to generative settings such as 3D generative adversarial networks (GANs) present challenges. For instance, although 3DGS's Gaussian representation is highly flexible, this unconstrained nature can lead to inconsistent global shapes when multi-view supervision is lacking. Additionally, because 3DGS is a point-based representation, it does not integrate seamlessly with state-of-the-art convolutional neural network (CNN)-based architecture that typically rely on continuous and structured feature spaces.

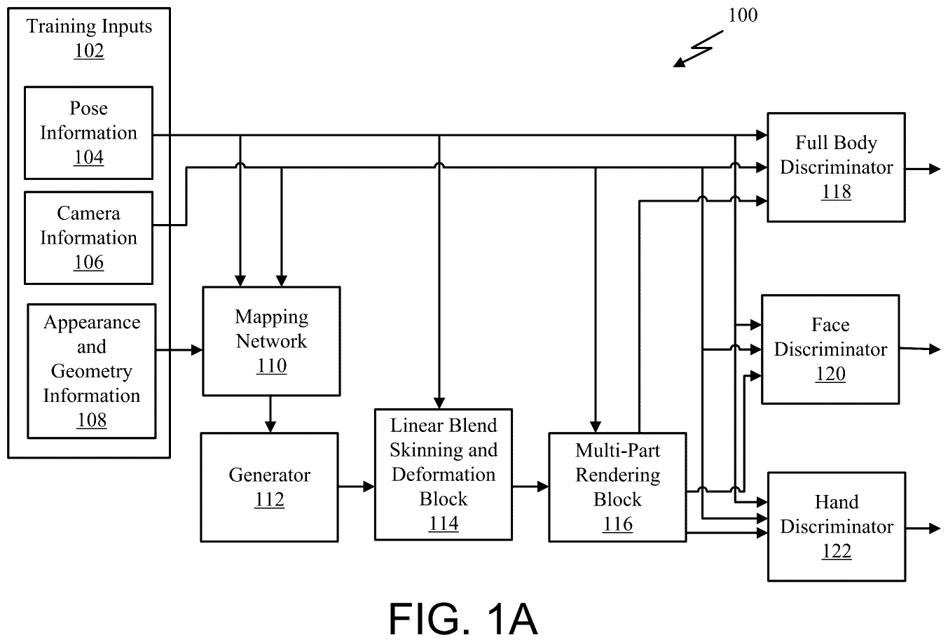

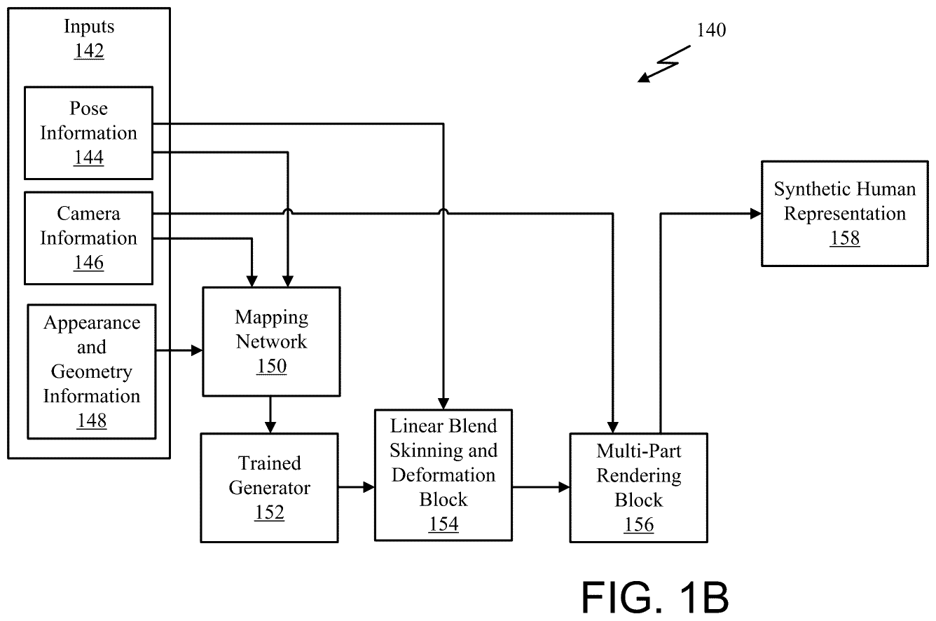

As such, embodiments of the present disclosure describe a foundational model, DHFM, that utilizes 3DGS for generative settings and accounts for the challenges of conventional approaches. The training process for the DHFM is initially described. For example, FIG. 1A shows a training process 100 for training a foundational model (e.g., the DHFM), in accordance with one or more embodiments of the present disclosure. Each block of process 100 as well as other processes described below comprises a computing process that may be performed using any combination of hardware, firmware, and/or software. For instance, various functions may be carried out by a processor executing instructions stored in memory. The processes described herein may also be embodied as computer-usable instructions stored on computer storage media. The processes described herein may be provided by a standalone application, a service or hosted service (standalone or in combination with another hosted service), or a plug-in to another product, to name a few. In addition, the processes described herein may be executed by any one system, or any combination of systems, including, but not limited to, those described herein. Furthermore, persons of ordinary skill in the art will understand that any system that is capable of performing the processes described herein is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

Turning to FIG. 1A, the training process 100 of the DHFM includes training inputs 102, a mapping network 110, a generator 112, linear blend skinning and deformation block 114, multi-part rendering block 116, and three discriminators—a full body discriminator 118, a face discriminator 120, and a hand discriminator 122. The three training inputs 102 include pose information 104, camera information 106, and/or appearance and geometry information 108.

For instance, the DHFM may feature an efficient generative 3D representation such as by parameterizing avatars using texel-aligned Gaussian maps and employing a generative adversarial network (GAN) training approach and/or architecture. For example, the training process 100 may utilize any type of GAN architecture such as, but not limited to, a style-based GAN architecture 2 (StyleGAN2), which is described by U.S. Pat. No. 11,455,790, titled “Style-based architecture for generative neural networks” (the '790 patent) and U.S. Pat. No. 11,580,395, titled “Generative adversarial neural network assisted video reconstruction” (the '395 patent), which are incorporated by reference herein in their entirety. However, whereas traditional GAN architectures use only a single discriminator, the training process 100 may utilize three discriminators 118-122. In addition, the generator 112 of the GAN architecture may generate texel-aligned Gaussian maps based on the training inputs 102, which accounts for the deficiencies of the conventional 3GDS process described above. Based on utilizing these improvements, embodiments of the present disclosure may allow for part-specific generation, specialized discriminator design, and carefully tuned regularizations that further reinforce geometric fidelity.

To perform the training process 100, a large-scale dataset (e.g., a training dataset) that is derived from a creative collection and synthetic sources may be used. The large-scale dataset may provide diverse poses, demographics, and/or high-quality annotations (e.g., Skinned Multi-Person Linear Model expressive (SMPL-X) poses, keypoints, and/or masks). With this extensive coverage, the DHFM not only tackles data limitations, but also enables a broad range of downstream tasks-including, but not limited to, generating custom 3D avatars and supporting multi-modal inputs (e.g., images and/or joints) for avatar customization. By unifying data diversity and a robust generative framework, embodiments of the present disclosure may set a new benchmark in scalable, efficient, and reusable digital human modeling that paves the way for advanced applications in gaming, telepresence, and beyond. The generation and curation of the large-scale dataset as well as exemplary use cases of the DHFM will be described in further detail below.

Using the large-scale training dataset, training inputs 102 including the pose information 104 and the camera information 106 may be obtained. For example, the training process 100 may obtain a 3D pose representation of a human, which may indicate a parametric representation of the shape and pose (e.g., body poses and/or facial expressions) of the human. For example, the large-scale training dataset may include a plurality of 2D images such as photos of humans “in-the-wild” and/or synthetic images. Additionally, and/or alternatively, as will be described in further detail below, the plurality of 2D images may be curated and/or processed to obtain pose data associated with the 2D images such as 2D and/or 3D data. For instance, the pose data may include 2D landmarks, 3D poses and/or expressions, and/or labels associated with the raw 2D images/photos. In addition, during the curation process, a composite 2D image that only includes the human may further be generated. In some examples, the 3D poses and/or expressions may include a 3D pose representation of a human that is shown in the 2D image (e.g., the raw or composite 2D image). For instance, the 3D pose representation may be a data representation such as one or more vectors (e.g., an expression, shape, and/or pose vector) that represent the human shown in the image. For example, the vectors may indicate the joints of the human (e.g., points within a 3D space indicating each joint), the connection between the joints (e.g., a connection between a first joint such as an elbow to a second joint such as a shoulder), pose of the human (e.g., the joints may be manipulated to indicate the pose such as the human leaning sideways or with one arm in front of the other in the 3D space), and/or other information. Additionally, and/or alternatively, the vectors may indicate facial expression of the human (e.g., whether the human is smiling and/or has their eyes open or closed).

The training process 100 may sample from the large-scale training dataset to obtain the pose information 104 (e.g., the 3D pose representation of the human shown in the sampled 2D image). For example, the training process 100 may sample the large-scale training dataset to obtain an image (e.g., a synthetic and/or “in-the-wild” image) from the large-scale training dataset. The training process 100 may further retrieve information associated with the image such as the 3D pose representation, which is described above. In some examples, the 3D pose representation that is retrieved by the training process 100 may indicate SMPL-X poses that are obtained using a SMPL-X model. For instance, the SMPL-X pose may indicate joints (e.g., joints such as joints for the neck, jaw, eyeballs, fingers, and so on), pose parameters (e.g., pose parameters that represent the rotations of the joints), shape parameters (e.g., shape parameters to characterize the variation of body height, body proportion, and/or weight), and/or facial expression parameters (e.g., to capture facial parameters of the human). Additionally, and/or alternatively, based on the 3D pose representation, a 3D mesh of the human may further be obtained (e.g., the vectors indicating the joints, the connections between the joints, and/or the shape parameters may indicate a 3D mesh of the human within the image).

In addition to obtaining the pose information 104 from the training dataset, the training process 100 may further obtain the camera information 106 (e.g., camera viewpoints and/or poses) from the training dataset. For instance, during processing and curation of the 2D images/photos, camera viewpoints and/or camera poses associated with the 2D images/photos may be obtained. When sampling the training dataset, the training process 100 may further obtain the camera information 106 associated with the sampled image.

The training process 100 may further obtain the appearance and geometry information 108. For example, the appearance and geometry information 108 may indicate and/or include latent code, which may be a one-dimensional (1D) vector comprising a plurality of dimensions (e.g., 512 dimensions) and is described in further detail in the '395 patent. The training process 100 may sample from Gaussian noise to randomly generate the latent code.

The training inputs 102, including the pose information 104, the camera information 106, and the appearance and geometry information 108 (e.g., the latent code), may be provided to the mapping network 110. For instance, the mapping network 110 may include similar functionality to the mapping neural network that is described in the '395 patent. However, in addition to the latent code (e.g., the appearance and geometry information 108), the pose information 104 and the camera information 106 (e.g., vectors indicating the camera viewpoints/poses and/or the 3D pose representation) may also be processed by the mapping network 110 to generate intermediate latent code that is defined in the intermediate latent space. As such, whereas the appearance and geometry information 108 includes latent code within a latent space (e.g., a first latent space), the intermediate latent code that is output from the mapping network 110 may be defined within another latent space (e.g., the intermediate or a second latent space).

The intermediate latent code may be provided to the generator 112. The generator 112 may be similar to the generator described in the '395 patent. For example, based on the intermediate latent code, the generator 112 (e.g., the StyleGAN2 generator described in the '395 patent) may generate output data. The output data may be, include, and/or indicate texel-aligned Gaussian maps for a human in the sampled image, and the texel-aligned Gaussian maps may be used in the 3DGS process. For instance, as mentioned above, the DHFM may utilize 3DGS as the core 3D representation due to its efficient rendering and expressive capacity. To address the unstructured nature of Gaussian-based representations, the DHFM rigs the Gaussian points within the UV space of a human-body mesh template, which provides a coherent reference for articulations. This UV-space rigging enforces a structured topology on the Gaussians, allowing the model to handle complex poses and occlusions effectively. Thus, by conditioning the 3D-aware GAN generator 112 on coarse body pose priors (e.g., SMPL-X poses) and viewpoints, embodiments of the present disclosure ensure both 3D-aware learning of full-body shape and high-fidelity alignment to the appearance distribution from the training dataset.

In other words, based on the intermediate latent code associated with the training inputs 102, the generator 112 may be used to generate texel-aligned Gaussian maps that are in the UV space (e.g., a 2D space having coordinates of “U” and “V”) for a 3D human mesh. Prior to describing the texel-aligned Gaussian maps, the interaction between a simple example of a 3D model such as a 3D globe and the UV space is first described. For instance, a UV map may be obtained that maps each coordinate point from the UV map to a respective coordinate point on the surface of the 3D globe. In this example, each coordinate point from the UV map may indicate a red, green, blue (RGB) value. Thus, the UV map may be a 2D representation of the 3D globe such that the 2D UV map represents an unfolding of the surface of the 3D globe. Therefore, by wrapping the UV map over the surface of the 3D globe, the attributes of the 3D globe (e.g., the continents and oceans indicated by the RGB values) may be observed.

Similarly, the generator 112 may generate texel-aligned Gaussian maps in the UV space for the 3D human mesh (e.g., a coarse template mesh) of the sampled image. For example, the generator 112 may process the intermediate latent code to generate texel-aligned Gaussian maps, which may comprise five parameters-scale parameters, opacity parameters, position parameters, rotation parameters, and feature parameters. In an embodiment, the generator 112 may include a plurality of output channels and each output channel may provide an output associated with one of the five parameters of the texel-aligned Gaussian maps (e.g., three channels may output the scale parameter, three channels may output the opacity parameter, and so on).

To put it another way, the texel-aligned Gaussian maps may be a shared UV texture map [symbol] of a coarse template mesh (e.g., a coarse 3D human mesh that is in a default position, which may be a T-pose and/or may be based on a pose and shape of a human of the sampled image). For instance, instead of the UV map in the 3D globe example above having RGB values, the texel-aligned Gaussian maps may be 2D Gaussian attribute maps that may be wrapped around the coarse 3D human mesh to indicate the attributes of the human including attributes directly on the coarse 3D human mesh (e.g., skin color) as well as attributes positioned away from the 3D human mesh such as hair color or clothing.

For instance, to represent the human, the texel-aligned Gaussian maps may include the five parameters described above. The scale parameters (e.g., Gaussian scale) may indicate the scale (e.g., length or size) of each of the coordinates of the Gaussian kernel. For example, each of the texel-aligned Gaussian maps may be associated with a 3D Gaussian kernel and initially, the Gaussian kernel may be represented by a ball. Based on the scale parameters, the Gaussian kernel may be manipulated to become an ellipsoid (e.g., based on the scale for the x, y, and z parameters for the Gaussian kernel). The opacity parameters may indicate the transparency of the Gaussian kernel. The rotation parameters may indicate the rotation of the Gaussian kernel (e.g., the rotation of the ellipsoid). The feature parameters may indicate features (e.g., color, clothing, and other features) of the Gaussian kernel. The position parameters may indicate the center of the Gaussian kernel. For example, in contrast to the UV map of the 3D globe, the texel-aligned Gaussian map may indicate attributes such as hair or clothing that are not solely on the surface of the 3D human mesh (e.g., the hair of the human may be slightly above the head of the 3D mesh of the human) Accordingly, the position parameters (as well as the rotation parameters) may include offsets, which indicate that such attributes are not directly on the surface of the 3D human mesh.

As such, the generator 112 may generate texel-aligned Gaussian maps comprising the five parameters indicated above for coordinate points in the UV space, which has a respective coordinate point in the 3D space (e.g., the 3D space of the coarse 3D human mesh). Thus, similar to the example of the 3D globe, the texel-aligned Gaussian map may wrap around the 3D human mesh to indicate attributes associated with each point on the human mesh. However, unlike the example of the 3D globe, based on the position and/or rotation parameters (e.g., offsets indicated by these parameters), additional features (e.g., hair or clothing) may further be indicated by the texel-aligned Gaussian map.

In other words, 3DGS, as a point-based representation, may be inherently unstructured, leading to issues such as order ambiguity and sparse distributions in 3D space that may hinder generative tasks. To address these limitations and leverage the structured nature of the human body, embodiments of the present disclosure may rig the Gaussians to a template mesh with a shared UV layout. This setup not only imposes a well-defined topology onto the unstructured Gaussians but also may simplify articulation and deformation through the mesh's parametric representation.

This UV parameterization may allow for adopting an efficient 2D generative backbone [symbol] , to predict the Gaussian representation [symbol] . Compared to alternative representations such as triplanes, texel-aligned feature maps may offer greater spatial efficiency and inherent structure, which is crucial for modeling complex human geometries. In some instances and as will be described below, embodiments of the present disclosure may attach primitives to a Linear Blend Skinning (LBS) model's output mesh (e.g., the output mesh from the linear blend skinning an deformation block 114), enabling inherent animatability and general articulated motion.

In some variations, the generator 112 may generate the texel-aligned Gaussian maps [symbol] (e.g., a shared UV texture map) of a coarse template mesh, which may be represented by the following:

$$ℱ = ℬ ( z , c , p )$$

where [symbol] is the backbone of the model (e.g., the model comprising the mapping network 110 and the generator 112), z is the latent code (e.g., the appearance and geometry information 108), c is the camera information 106, and p is the pose information 104. Thus, the mapping network is conditioned on the camera pose and the body pose to help facilitate the learning of the joint distribution and enhance the model's ability to accurate fit the complex data distribution.

In some examples, the generator 112 may provide Gaussian attributes (e.g., the generated texel-aligned Gaussian maps) to the linear blend skinning and deformation block 114. Additionally, and/or alternatively, after obtaining the texel-aligned Gaussian maps, the actual 3D Gaussian primitives for the 3DGS may be obtained, which may be used to render the image. For instance, the texel-aligned Gaussian map may be uniformly sampled to generate the actual 3D Gaussian primitives and each of the 3D Gaussian primitives may be assigned a fixed coordinate the template's UV space. In some instances, embodiments of the present disclosure may use grid sampling (GridSample), which is shown below to obtain the 3D Gaussian primitives from the texel-aligned Gaussian maps:

$$\{ {δμ}_{i} , {q}_{i} , {s}_{i} , {o}_{i} \} = GridSample ( ℱ , ( {u}_{i} , {v}_{i} ) )$$

where [symbol] is the texel-aligned Gaussian map, (uᵢ, vᵢ) is are the normalized UV coordinates of the i-th Gaussian point, and δμᵢ, qᵢ, sᵢ, oᵢ are the 3D Gaussian primitives (e.g., the Gaussian center, scale, rotation parameterized as a quaternion, color, and opacity). The 3D Gaussian primitives that are obtained from texel-aligned Gaussian maps may be provided to the linear blend skinning and deformation block 114. In other words, the Gaussian attributes that are provided to the linear blend skinning and deformation block 114 may include the generated texel-aligned Gaussian maps and/or the 3D Gaussian primitives.

The linear blend skinning and deformation block 114 may position the Gaussians (e.g., the texel-aligned Gaussian maps and/or the 3D Gaussian primitives) into their expected positions based on the pose information 104 (e.g., the SMPL-X pose p) and/or perform tangent-space deformation. For instance, in some examples, initially, the 3D human mesh (e.g., a coarse template mesh) may be in a default human pose such as the T-pose and the generator 112 may generate the texel-aligned Gaussian maps for the default human pose. Following, the linear blend skinning and deformation block 114 may be performed to modify and align the 3D human mesh and the Gaussian attributes to a pose indicated by the sampled image. For instance, the linear blend skinning and deformation block 114 may obtain the pose information 104 and Gaussian attributes. Subsequently, the linear blend skinning and deformation block 114 may rotate the “bones” of the 3D pose representation of the human from the sampled raw image/photo based on the pose information 104. For instance, as mentioned above, the pose information 104 (e.g., vectors included within the pose information 104) may indicate the joints of the human as well as the connectors (e.g., “bones”) between the joints. As such, a movement of a joint such as the elbow would impact the placement of not only the elbow joint but also a joint in the hand as well. Similarly, a rotation of a forearm bone (e.g., the connector between the elbow joint and the hand joint) may cause a rotation of the upper arm bone (e.g., the connector between the elbow joint and the shoulder joint). Accordingly, initially, based on the pose information 104, the linear blend skinning and deformation block 114 may rotate and/or orient the vectors indicating the joints and/or connectors associated with the joints (e.g., “bones”) based on the pose indicated within the sampled raw image.

After rotating and aligning the “bones,” the linear blend skinning and deformation block 114 may align and/or move the coarse 3D human mesh from the default position to a position that is based on the rotation of the connectors and/or joints from the first step (e.g., align the coarse 3D human mesh to the pose of the human within the sampled raw image). For example, the linear blend skinning and deformation block 114 may change the positioning of the 3D human mesh from a default position (e.g., a default x, y, and z coordinate) to a new position (e.g., a new x, y, and z coordinate) based on the rotation of the connectors and/or joints.

Subsequently, the linear blend skinning and deformation block 114 may change the positioning associated with the Gaussian attributes to the new position based on the updated 3D human mesh. For example, initially, the output from the generator 112 may indicate a position for each of the texel-aligned Gaussian maps in the UV space. Based on moving the 3D human mesh to a new position, the position associated with each of the texel-aligned Gaussian maps and/or the 3D Gaussian primitives obtained from the texel-aligned Gaussian maps may also be moved to the new position in the UV space. As such, given the relationship between the UV space and the XYZ coordinate space, the linear blend skinning and deformation block 114 may align the Gaussian attributes to a position along the 3D human mesh that matches the pose of the human within the sampled image.

Additionally, and/or alternatively, embodiments of the present disclosure may further perform tangent space Gaussian motion and cone regularization (e.g., using a cone or conical constraint to constrain the offsets from the position and rotation parameters of the texel-aligned Gaussian maps). For instance, because 3D Gaussian points attached directly to a coarse template mesh are limited in capturing complex topologies such as hair or loose clothing, to enhance flexibility, the generator 112 may be used to generate texel-aligned Gaussian maps that include position and/or rotation offsets for each Gaussian (e.g., each 3D Gaussian primitive) in the local tangent space of the 3D human mesh. For instance, for each Gaussian point [symbol] on the template mesh (e.g., for each 3D Gaussian primitive), a local tangent frame represented by the tangent vectors t₁ and t₂, and the normal vector n may be defined. These vectors may form an orthonormal basis known as the Tangent, Bitangent, and Normal (TBN) frame, and because of these three vectors, a cone may be formed. The TBN rotation matrix Rᵢ for the i-th Gaussian point [symbol] , which aligns the local tangent space of the Gaussian point with the global coordinate system, may be constructed from these vectors as follows:

$${R}_{i} = [ {t}_{1} {t}_{2} n ] .$$

The generator 112 predicts position offsets μᵢ and rotation offsets qᵢ (in quaternions) for each Gaussian point. By defining μᵢ in the local tangent space, these offsets are “anchored” to each point's neighborhood rather than to a global frame. This may prevent large pose changes (e.g., an arm rotating) from unintentionally magnifying or skewing the deformations, ensuring they remain stable and pose independent. The transformation from local tangent space to global space is performed using the rotation matrix Rᵢ:

$$\begin{matrix}{x}_{i}^{′} = {x}_{i} + {R}_{i} {μ}_{i} \\ {R}_{i}^{′} = Q ( {q}_{i} ) {R}_{i} .\end{matrix}$$

where Q(qᵢ) converts the quaternion qᵢ to a rotation matrix;

$${x}_{i}^{′} and {R}_{i}^{′}$$

are the deformed position and the rotation matrix of the Gaussian, respectively. The rotation matrix Rᵢ may be based on obtaining a tangent space formed by a pre-defined normal mesh. By modeling deformations in the tangent space, embodiments of the present disclosure may achieve stable and expressive 3D Gaussian motions, effectively capturing intricate details and complex topologies while maintaining robustness under varying poses.

Furthermore, the linear blend skinning and deformation block 114 may also perform a cone constraint that restricts each Gaussian's displacement μᵢ to lie within a cone defined around its attached surface triangle's normal direction and tangent plane (e.g., based on the TBN vectors that define a cone for the Gaussian point). This may ensure that the Gaussian deformation remains primarily along tangential directions, preventing excessive deviation in the normal direction and keeping the Gaussian motion close to the surface of the original mesh. This is achieved through two main steps. First, the x and y components of the position offset μᵢ are scaled by a factor s to reduce the degrees of freedom:

$${μ}_{i}^{scaled} = [ \begin{matrix}s \cdot {μ}_{i , x} \\ s \cdot {μ}_{i , y} \\ {μ}_{i , z}\end{matrix} ] .$$

Second, a cone constraint κᵢ is applied by scaling the x and y components based on the z component, forming a cone-shaped displacement:

$$\begin{matrix}{κ}_{i} = max ( 1 - \vert {μ}_{i , z} \vert , ϵ ) , \\ {μ}_{i}^{cone} = [ \begin{matrix}{κ}_{i} \cdot {μ}_{i , x}^{scaled} \\ {κ}_{i} \cdot {μ}_{i , y}^{scaled} \\ {μ}_{i , z}\end{matrix} ] .\end{matrix}$$

Here, s is a predefined scaling factor (e.g., s=0.5), and ϵ is a small constant (e.g., ϵ=1×10⁻⁶) to prevent division by zero. This cone constraint ensures that as the normal displacement (μ_{i,z}) increases, the tangential displacements (μ_{i,x} and μ_{i,y}) are proportionally reduced, maintaining realistic deformations that do not stray away drastically from the human-body shape. Therefore, the global Gaussian position is updated to:

$${x}_{i}^{′} = {x}_{i} + {R}_{i} {μ}_{i}^{cone} .$$

In other words, the linear blend skinning and deformation block 114 may perform four steps: 1) rotating and aligning the “bones”; 2) aligning and/or moving the coarse 3D human mesh from the default position to a new position; 3) changing the positioning associated with the Gaussian attributes to the new position; and 4) performing deformation and cone constraint. Regarding step 4, to allow for capturing of complex topologies (e.g., hair and hair color), the generator 112 may generate texel-aligned Gaussian maps comprising position offsets μᵢ and rotation offsets qᵢ. However, if the offsets are too extreme, realism may be lost. Thus, the linear blend skinning and deformation block 114 utilizes a cone constraint based on the TBN vectors to maintain realistic deformations that do not stray too drastically from the human-body shape. For example, the initial position offset μᵢ from the generator 112 may be scaled by a factor s to reduce the degrees of freedom. Subsequently, the linear blend skinning and deformation block 114 may apply a cone constraint κᵢ to the scaled position offset

$${μ}_{i}^{scaled}$$

to generate a cone constrained position offsets

$${μ}_{i}^{cone} .$$

For example, by using the cone constraint κᵢ, the linear blend skinning and deformation block 114 ensures that as the normal displacement (μ_{i,z}) (e.g., the displacement away from the surface of the 3D mesh) increases, the tangential displacements μ_{i,x} and μ_{i,y} (e.g., the displacements on the surface of the 3D mesh) are proportionally reduced. This forces the 3D Gaussian primitives to be constrained to the cone defined by the TBN vectors. Subsequently, based on the rotation matrix Rᵢ that is constructed by the TBN vectors, the linear blend skinning and deformation block 114 transforms the 3D Gaussian primitives from the local tangent space (e.g., defined by the TBN vectors) to the global space. For example, based on the TBN rotation matrix Rᵢ, the cone constrained position offsets

$${μ}_{i}^{cone} ,$$

and the initial global coordinate point xᵢ associated with the 3D Gaussian primitive, the linear blend skinning and deformation block 114 determines the deformed global position

$${x}_{i}^{′}$$

for the 3D Gaussian primitive. Similarly, based on the TBN rotation matrix Rᵢ and a function that converts the rotation offset q; to a rotation matrix (e.g., Q(qᵢ)), the linear blend skinning and deformation block 114 determines the deformed rotation matrix for the 3D Gaussian primitive. As such, based on using the four steps described above, the linear blend skinning and deformation block 114 may achieve stable and expressive 3D Gaussian motions that effectively capture intricate details and complex topologies while maintaining robustness under varying poses.

Subsequently, after performing the cone constraint, the linear blend skinning and deformation block 114 may provide the modified Gaussian attributes to the multi-part rendering block 116. The multi-part rendering block 116 may obtain inputs such as the modified Gaussian attributes (e.g., the modified 3D Gaussian primitives) and the camera information 106 (e.g., the camera coordinates) and render a full-bodied image of the human based on the inputs. For example, as mentioned previously, based on the 3D Gaussian primitives, the multi-part rendering block 116 may use 3DGS to render an image using EWA volume splatting. As such, based on using blocks 102-114 as well as blocks 116-122, the DHFM enables seamless integration with state-of-the-art CNN-based architecture (e.g., the mapping network 110 and the generator 112) as well as constraining the 3D Gaussian primitives to render consistent global shapes without using multi-view supervision.

Furthermore, while employing a single discriminator may allow for overall realism, it may overlook finer details for compositional structures such as the human body. Specifically, the face and hands of the human body critically affect perceptual quality and realism, and as such, the DHFM may utilize more than one discriminator for the critical body parts, which may ensure high-fidelity synthesis of these specific regions. For example, as shown in FIG. 1A, the DHFM employs three discriminators—a first discriminator 118 for the full body, a second discriminator 120 for the facial features, and a third discriminator 122 for the hands. The three discriminators 118-122 are merely exemplary and the DHFM may employ any number of discriminators including one, two, five, or even additional discriminators.

In some embodiments, the multi-part rendering block 116 may crop the rendered image of the human and provide the cropped images to one or more of the discriminators. For example, the multi-part rendering block 116 may use bounding boxes to generate cropped images of the hands and the face of the human and provide the cropped images to the corresponding discriminators 120 and 122. For instance, for each part (e.g., face or hands), embodiments of the present disclosure may retrieve the corresponding set of 3D vertices from the body model. By applying camera projection, embodiments of the present disclosure may map these vertices to 2D rendered pixel coordinates. The bounding box encompassing the part may then be the smallest axis-aligned rectangle enclosing those projected coordinates. Suppose each part's bounding box (bbox) in pixel space is:

$$bbox = [ {bbox}_{min} , {bbox}_{max} ] ,$$

with center c and side length s. Let W be the original image width, and “output_size” the target rendering resolution. Embodiments of the present disclosure may define:

$$ratio = \frac{output\_size}{W} , crop\_ratio = \frac{W}{s} .$$

Embodiments of the present disclosure may shift and scale the camera's center to:

$${c}^{′} = ( c - \frac{W}{2} ) \cdot ( ratio \cdot crop\_ratio ) + \frac{output\_size}{2} ,$$

and multiply the focal lengths in the camera's intrinsics by “crop_ratio.” This may yield a new intrinsics matrix K′, which renders the region of interest at size output_size×output_size. This way, each part discriminator sees a consistent, high-resolution 2D projection focused on the specific body region, enhancing realism and preserving crucial local detail.

The discriminators 118-122 may obtain an image from the multi-part rendering block 116 as well as corresponding pose information 104 and/or camera information 106. For example, the full body discriminator 118 may obtain the original image that is rendered by the multi-part rendering block 116 (e.g., the uncropped and complete image of the human) as well as the pose information 104 indicating the complete pose of the human. The full body discriminator 118 may process the pose information 104, the camera information 106, and the original rendered image to generate a full body discriminator output. However, given that the face discriminator 120 is utilized to analyze only a portion of the original rendered image, the face discriminator 120 might not obtain the complete pose information 104 and/or the uncropped rendered image. Instead, the face discriminator 120 may obtain a portion of the pose information 104 that is associated with the face (e.g., the facial expression and/or neck poses from the 3D poses and/or expressions) and the cropped rendered image of the face of the human. The face discriminator 120 may process the portion of the pose information 104, the cropped rendered image of the face, and the camera information 106 to generate a face discriminator output. Similarly, the hand discriminator 122 may obtain a second portion of the pose information 104 that is associated with the hand and the cropped rendered image of the hand. The hand discriminator 122 may process the second portion of the pose information 104, the cropped rendered image of the hand, and the camera information 106 to generate a hand discriminator output.

Based on the output(s) of the discriminators 118-122, embodiments of the present disclosure may perform GAN training to train the DHFM. For example, the discriminators 118-122 may process the fake images from the multi-part rendering block 116 as well as images (e.g., synthetic and/or real “in-the-wild” images) from the large-scale dataset to generate discriminator outputs (e.g., full body, face, and/or hand discriminator outputs) indicating whether the image is a real or fake image. Based on the discriminator outputs, the DHFM may be trained. In addition, whereas conventional discriminators may be conditioned on merely the images (e.g., the rendered image or images from the large-scale dataset), the DHFM includes discriminators 118-122 that are further conditioned on the pose information 104 and the camera information 106.

In addition to the conventional adversarial loss [symbol] that is used in GAN training, embodiments of the present disclosure may further use one or more additional losses to train aspects of the DHFM such as the generator 112. For example, the one or more additional losses may include, but are not limited to, a Gaussian position regularization loss [symbol] , a Gaussian scale regularization loss [symbol] , and/or a Gaussian opacity regularization loss [symbol] . The Gaussian position regularization loss may be used to discourage the generated Gaussians of the generator 112 from drifting excessively away from the template mesh (e.g., the coarse template mesh). For instance, based on cone constrained position offsets

$${μ}_{i}^{cone} ,$$

which is described above, embodiments of the present disclosure may determine the Gaussian position regularization loss [symbol] offset. For instance, the offset δ of the i-th element in tangent (Δt), bitangent (Δb), and normal (Δn) directions for each of the 3D Gaussian primitives may be calculated based on the

$${μ}_{i}^{cone}$$

and δ. This is shown by the expression below:

$$δ {μ}_{i}^{cone} = [ Δ t , Δ b , Δ n ]$$

Thus, after obtaining [Δt, Δb, Δn], the Gaussian position regularization loss [symbol] may be computed based on the below:

$${ℒ}_{pos \_ offset} = {λ}_{t} {‖ Δ t ‖}^{2} + {λ}_{b} {‖ Δ b ‖}^{2} + {λ}_{n} {‖ Δ n ‖}^{2}$$

where λₜ, λ_{b}, λₙ are tangent, bitangent, and normal hyperparameters that control the per-direction penalty. As such, by separately penalizing each component, embodiments of the present disclosure may mitigate the coupling introduced by cone-space transformations, which may lead to more stable optimization and clearer interpretability of local shape deformations.

Additionally, and/or alternatively, a Gaussian scale regularization loss [symbol] may be computed, which may be used to avoid Gaussians with very large scales. For example, the texel-aligned Gaussian maps that are generated by the generator 112 may include scale parameters sᵢ. Using a hyperparameter λₛ and the scale parameters sᵢ, embodiments of the present disclosure may determine the Gaussian scale regularization loss [symbol] . This is shown in the below expression:

$${ℒ}_{scale} = {λ}_{s} {‖ {s}_{i} ‖}^{2}$$

Additionally, and/or alternatively, a Gaussian opacity regularization loss [symbol] may be computed, which may encourage the Gaussians to either be fully transparent or fully opaque. The Gaussian opacity regularization loss [symbol] may be computed using a beta regularization on the opacities, which is shown in the below expression:

$${ℒ}_{opac} = Beta ( {o}_{i} )$$

where Beta is the negative log-likelihood of a Beta(0.5,0.5) distribution.

As mentioned above, based on the adversarial loss [symbol] and one or more additional losses, aspects of the DHFM such as the generator 112 may be trained. For example, in an embodiment, the generator 112 may be trained using the total loss [symbol] , which may be based on the below expression:

$${ℒ}_{total} = {ℒ}_{adv} + {λ}_{pos} {ℒ}_{pos \_ offset} + {λ}_{scale} {ℒ}_{scale} + {λ}_{opac} {ℒ}_{opac}$$

where the position hyperparameter λₚₒₛ, the scale hyperparameter λ_{scale}, and the opacity hyperparameter λ_{opac} control the relative weighting of each regularization term.

In some examples, the DHFM may include more than one discriminator (e.g., discriminators 118-122 shown in FIG. 1A). As such, the adversarial loss [symbol] may be based on the losses of all of the discriminators (e.g., may be based on summing the losses of the three discriminators 118-122). Additionally, and/or alternatively, for each training iteration and even if the DHFM includes multiple discriminators, the training process might not use all of the discriminators. For example, in a first set of iterations (e.g., 100 training iterations), a first discriminator such as the full body discriminator 118 may be used. Thus, the adversarial loss [symbol] used to train the DHFM may be the adversarial loss [symbol] associated with the full body discriminator 118. Then, in a second set of iterations (e.g., the next 100 training iterations), the adversarial loss [symbol] for a second discriminator (e.g., the face discriminator 120) may be used to train the DHFM. Subsequently, in a third set of iterations (e.g., the following 100 training iterations), the adversarial loss [symbol] for a third discriminator (e.g., the hand discriminator 122) may be used to train the DHFM. This training process may continue to repeat.

In some examples, embodiments of the present disclosure may utilize Gaussian position offset modeling. For example, to mitigate early training collapse where renderings generated by the multi-part rendering block 116 with drifting Gaussians are easily classified as fake by the discriminators 118-122, embodiments of the present disclosure may begin with smaller Gaussian offsets and gradually increase them over time. To implement this, embodiments of the present disclosure may append a single-layer convolutional network specifically to the Gaussian position offset map, ensuring the other components remain unaffected. The convolution layer may be initialized with a small positive bias instead of zero to avoid generating “inverted” shapes. Further, to address challenges such as loose clothing or hair, embodiments of the present disclosure may skip activation functions and instead utilize the Gaussian position regularization loss [symbol] , which is described above and may help prevent the offsets from drifting excessively during training. In some examples, the single-layer convolutional network may be connected to the output channels of the generator 112 that are used to generate the position parameters, and this convolutional network may be initialized with a small positive bias.

In some variations, embodiments of the present disclosure may perform progressive training. For example, the training of the DHFM may initially utilize a rendering resolution of 256×256, and may progressively increase (e.g., a linear increase) after a specified number of training iterations. In some instances, the discriminators 118-122 may be fed high-resolution images throughout the training process. These high-resolution images may be generated by bi-linearly upsampling the rendered images from the multi-part rendering block 116 during training prior to passing them into the discriminators 118-122. In other words, an upsampling block may be included between the multi-part rendering block 116 and the discriminators 118-122. The upsampling block may upsample the rendered images output by the multi-part rendering block 116 prior to providing the upsampled rendered images to the discriminators 118-122. Additionally, and/or alternatively, the resolution of the Gaussian UV map (e.g., the texel-aligned Gaussian maps) that are output from the generator 112 may further be scaled in parallel with the growth of the rendering resolution of the multi-part rendering block 116. This may result in a gradual increase in the number of Gaussians (e.g., from 65,000 to 260,000).

As such, embodiments of the present disclosure adopt a 3D-aware GAN that efficiently learns 3D representations from unpaired 2D images, which may eliminate the need for explicit 3D supervision and may enable the model to scale with large datasets. For instance, learning 3D human avatars from unstructured 2D images may be challenging due to the articulated nature of the human body and frequent self-occlusions. Different poses and occluded body parts complicate the inference of a consistent 3D structure without explicit 3D supervision. Variations in clothing, body shapes, and camera viewpoints may add further complexity. In a weakly supervision solely from 2D adversarial discriminators, the generator model may be required to disentangle shape, pose, and appearance from 2D observations, requiring robust generative and geometric representations to handle the diversity and occlusions in real-world datasets.

To address these challenges, embodiments of the present disclosure may begin by rigging Gaussian points within the UV space of a human-body mesh template. This UV-space rigging provides a coherent reference for articulations and enables the 3DGS-based representation from embodiments of the present disclosure to handle complex poses and occlusions effectively. Further, embodiments of the present disclosure may train and use a generator 112 that produces texel-aligned Gaussian maps, which may leverage established CNN-based generative backbones. This process may seamlessly incorporate a parametric deformation model for articulation. Beyond conventional blend skinning, embodiments of the present disclosure may enable non-rigid deformations of these Gaussian points by predicting tangent-space offsets subject to conical constraints. To capture high-detail regions such as the face and hands, embodiments of the present disclosure may adopt a multi-part rendering strategy. Specifically, embodiments of the present disclosure may allocate more attention to these regions, allowing for a higher feature resolution and improved detail in the rendered outputs. Alongside this, embodiments of the present disclosure may introduce a multi-part discriminator (e.g., discriminators 118-122) that evaluate both global and local (e.g., facial and hand) details, ensuring consistency across different parts of the human avatar and improving the overall quality of the generated images. Furthermore, embodiments of the present disclosure introduce several regularization terms for the Gaussian attributes that are crucial for stable training in a generative setting.

After training, the DHFM may be used to generate 3D synthetic human representations (e.g., 3D human avatars, images, and/or videos). This is described in further detail in FIG. 1B.

FIG. 1B shows a synthetic human representation generation process 140 that uses the DHFM to generate synthetic human representations 158, in accordance with one or more embodiments of the present disclosure. For example, FIG. 1B shows a synthetic human representation generation process 140 that uses the DHFM to generate synthetic human representations. For instance, the process 140 includes inputs 142, a mapping network 150, a generator 152, linear blend skinning and deformation block 154, multi-part rendering block 156, and a synthetic human representation 158. The three inputs 142 include pose information 144, camera information 146, and/or appearance and geometry information 148.

The blocks 142-156 from the process 140 may function similarly to the blocks 102-116 of the training process 100. For example, the pose information 144 and the camera information 146 may be obtained (e.g., sampled) from the large-scale training dataset. Furthermore, the process 140 may sample from Gaussian noise to randomly generate the appearance and geometry information 148 (e.g., the latent code). In some examples, instead of obtaining the pose information 144 based on sampling from the large-scale training dataset, the pose information 144 may be obtained based on user input. For example, a user may provide user input indicating features and/or poses that the user may desire. Based on processing the user input, the process 140 may obtain the pose information 144 (e.g., poses and/or features) associated with the user input.

The mapping network 150, the trained generator 152, the linear blend skinning and deformation block 154, and the multi-part rendering block 156 may function similarly to their counterparts in FIG. 1A. For example, the mapping network 150 may obtain the inputs 142 and process the inputs 142 to generate intermediate latent code. The trained generator 152 may generate texel-aligned Gaussian maps based on processing the intermediate latent code. The linear blend skinning and deformation block 154 as well as the multi-part rendering block 156 may utilize the texel-aligned Gaussian maps and/or the inputs 142 to generate a synthetic human representation 158. For instance, the synthetic human representation 158 may be a human representation that is based on the pose information 144 (e.g., the pose information 144 sampled from the training dataset and/or from the user input). For instance, based on the inputs 142, the synthetic human representation 158 (e.g., a random 3D synthetic human representation) may be a full-bodied avatar, image, and/or video of a synthetic human that includes the face, hands, and body of the synthetic human. In some instances, the synthetic human representation 158 may be a 3D avatar of a human. Based on user input (e.g., camera pose and/or orientation information), images of the human from different perspectives may be generated. For example, based on a first user input indicating first camera coordinates, an image of a frontal view of the human may be generated. Based on a second user input indicating second camera coordinates, an image of a side view of the human may be generated. Additionally, and/or alternatively, the user input may further indicate poses and/or expressions of the human such as the human running or walking. Based on the user input, an image of the human running or walking may be generated.

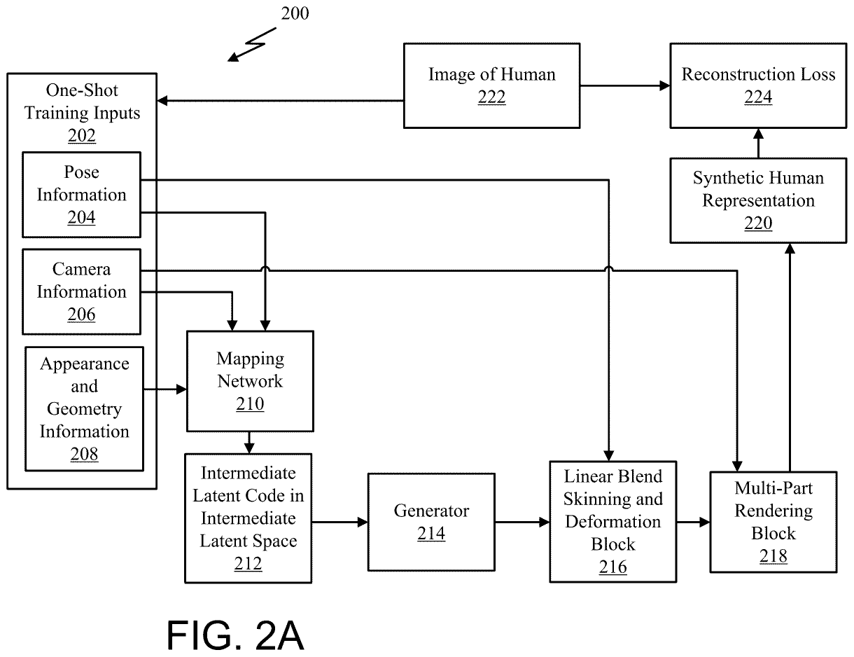

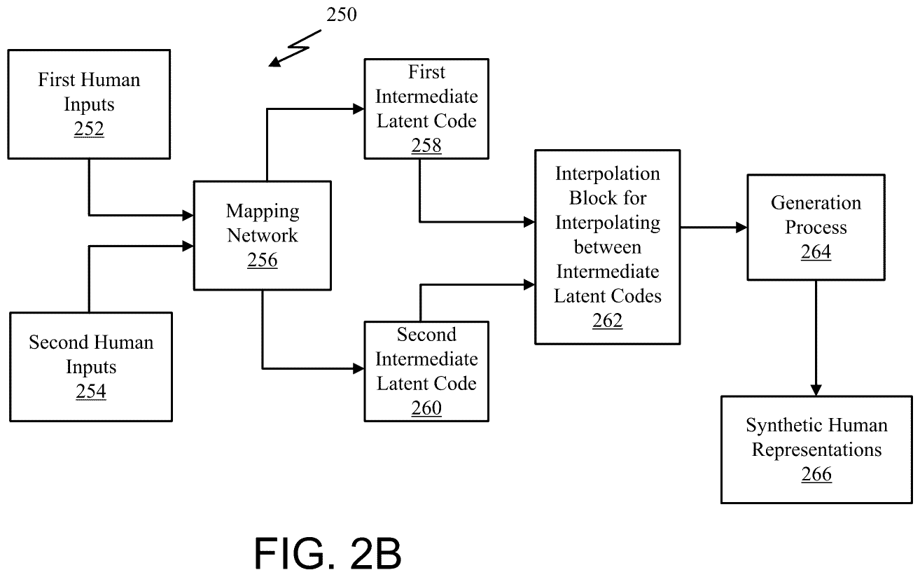

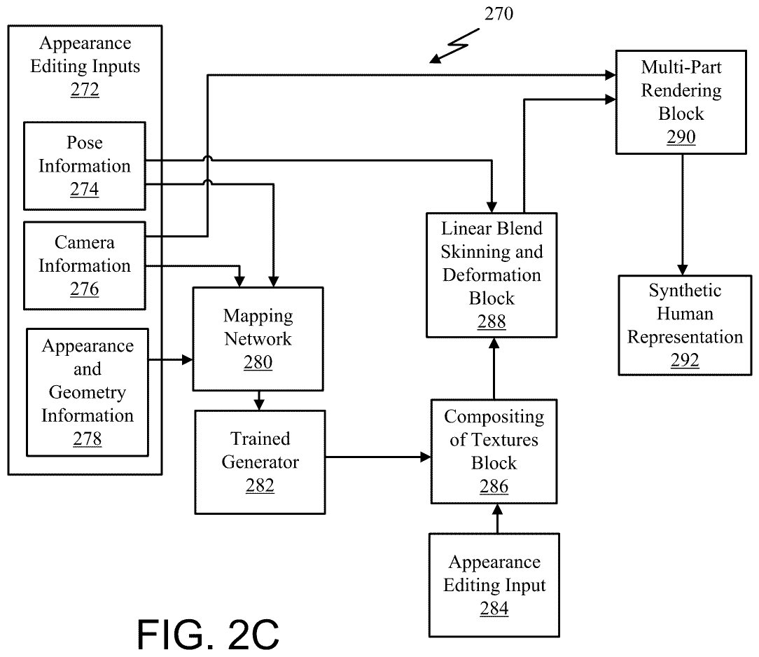

In some embodiments, the DHFM may be used in a variety of additional and/or alternative applications. For instance, the DHFM may be used for one-shot 3D human reconstruction. For example, the learned generative animatable 3D digital human representation, with an expressive latent space, may serve as a robust 3D prior for high-fidelity one-shot 3D human reconstruction and animation. Specifically, embodiments of the present disclosure use the data processing pipeline described above to extract pose information (e.g., SMPL-X labels) and camera information 106 (e.g., camera parameters) from reference images, which in some examples, may be a cropped version of the image at a particular resolution (e.g., a resolution of 512×512). In some instances, for the one-shot 3D human reconstruction, embodiments of the present disclosure may optimize the latent code for a set number of iterations (e.g., 500 iterations) and follow this by fine-tuning the generator weights for an additional number of iterations (e.g., 1000 iterations) to reconstruct the given image. The generated digital human representation (e.g., the generated digital human avatar) obtained using the one-shot 3D human reconstruction may be driven by novel poses, with the global shape remaining consistent across different poses and viewpoints. This is described in further detail in FIG. 2A.

FIG. 2A shows a one-shot training process 200 for one-shot generation of 3D synthetic human representations, in accordance with one or more embodiments of the present disclosure. For example, process 200 includes one-shot training inputs 202, a mapping network 210, intermediate latent code in the intermediate latent space 212, a generator 214, linear blend skinning and deformation block 216, multi-part rending block 218, a synthetic human representation 220, an image of a human 222, and a reconstruction loss 224. For instance, the one-shot training process 200 may be performed after performing the training process 100. In other words, the generator 214 may be the same generator 112 after performing the training process 100 (e.g., based on using the losses described above).

The one-shot training process 200 may include a first phase and a second phase. For instance, in the first phase, the intermediate latent space for the intermediate latent code may be optimized. Then, in the second phase, the weights and/or parameters of the generator 214 may be further fine-tuned. In some examples, the one-shot training process 200 may perform the first phase for a first number of iterations (e.g., 500 iterations) and the second phase for a second number of iterations (e.g., 1000 iterations).

In operation, an image of a human 222 (e.g., an “in-the-wild” image or a synthetic image that has at least one human visible within the image) may be obtained. For instance, the one-shot training process 200 may sample from the training dataset to obtain the image 222. Subsequently, one-shot training inputs 202 may be obtained based on the image 222. For example, one or more extraction algorithms may be performed to obtain the one-shot training inputs 202 from the image 222. As such, the pose information 204 may be the pose information associated with the obtained image 222 (e.g., the 3D pose representation of the human from the image 222). Similarly, the camera information 206 may be the camera information (e.g., the camera parameter from the image 222). The mapping network 210 may obtain the one-shot training inputs 202 and similar to the training process 100, the mapping network 210 may generate intermediate latent code in the intermediate latent space 212. Following, the generator 214 may process the intermediate latent code in the intermediate latent space 212 to generate the texel-aligned Gaussian maps. Then, using the texel-aligned Gaussian maps and/or the one-shot training inputs 202, the linear blend skinning and deformation block 216 and the multi-part rendering block 218 may generate the synthetic human representation 220 (e.g., a generated synthetic image of the human). The one-shot training process 200 may compare the image of the human 222 with the synthetic human representation 220 to determine (e.g., compute) the reconstruction loss 224. The reconstruction loss 224 may be used to train different aspects of the one-shot training process 200 during the first phase and the second phase.

For example, during the first phase, the intermediate latent code in the intermediate latent space 212 that is output from the mapping network 210 may be further optimized using the reconstruction loss 224. In other words, based on the reconstruction loss 224, the parameters of the intermediate latent space, which is described in further detail in the '395 patent, may be optimized to better define the geometries and appearance of the obtained image 222 (e.g., the one-shot training inputs 202).

After completing the first number of iterations (e.g., 500 iterations), the one-shot training process 200 may perform the second phase. During the second phase, the functional aspects of the blocks 202-224 of the one-shot training process 200 may operate similarly. However, instead of optimizing the intermediate latent space, the generator 214 is further trained. In other words, the second phase of the one-shot training process 200 may perform fine-tuning of the generator 214. For example, the weights and/or parameters of the generator 214 may be further updated and/or modified based on the reconstruction loss 224.

After further training the DHFM, the DHFM may perform one-shot generation of synthetic human representations. For example, the further trained DHFM (e.g., the DHFM that is further trained for one-shot generation of synthetic human representations) may be used in the synthetic human representation generation process 140 described in FIG. 1B to generate synthetic human representations. However, instead of using the intermediate latent space and the trained generator 152 that is described above in FIG. 1B, the synthetic human representation generation process 140 may use the optimized intermediate latent space and the fine-tuned generator 214 that is described in FIG. 2A. Furthermore, the further trained DHFM may be used for additional applications such as the latent space interpolations and/or the appearance editing process, which are described below in FIGS. 2B and 2C below.

In an embodiment, the DHFM may be used for latent space interpolations. For example, given that DHFM is based on a 3D GAN-based architecture, the DHFM may retain the beneficial latent space interpolation of GANs. For instance, two latent codes (e.g., z₁ and z₂) may be sampled, and interpolation may be performed in the intermediate latent space. The DHFM's intermediate latent space was shown to exhibit smooth transitions, which indicates that the intermediate latent space has good continuity and a well-structured geometry. This embodiment is described in further detail in FIG. 2B.

FIG. 2B shows an intermediate latent space interpolation process 250, in accordance with one or more embodiments of the present disclosure. The process 250 includes first and second human inputs 252-254, the mapping network 256, the first and second intermediate latent codes 258-260, the interpolation block 262 for interpolating between the intermediate latent codes 262, the generation process 264, and the synthetic human representations 266. The generation process 264 may include aspects and/or functionalities that are described within the previous FIGs. such as the trained generator 152, the linear blend skinning and deformation block 154, and the multi-part rendering block 156 from FIG. 1B.

The first human inputs 252 and the second human inputs 254 may include inputs similar to the inputs described within the previous FIGs. such as the inputs 142 from FIG. 1B. For example, the first human inputs 252 may include first pose information, first camera information, and first appearance and geometry information. Likewise, the second human inputs 254 may include second pose information, second camera information, and second appearance and geometry information. In some instances, the first pose information, the second pose information, and/or other information from the human inputs 252-254 may be based on sampling the training dataset and/or based on user input (e.g., the user may provide user input indicating the first and/or second pose information).

The mapping network 256 may function similar to the mapping networks described previously (e.g., the mapping network 150 from FIG. 1B) and may process the first and second human inputs 252-254 to generate the first and second intermediate latent code 258-260. Specifically, the mapping network 256 may process the first human inputs 252 to generate the first intermediate latent code 258 and may process the second human inputs 254 to generate the second intermediate latent code 260. As mentioned previously, given that the intermediate latent space has good continuity and a well-structured geometry, interpolating between the two intermediate latent codes 258-260 may result in great results. For example, the interpolation block 262 may linearly interpolate between the two intermediate latent codes 258-260 to obtain a plurality of interpolated intermediate latent codes. For instance, each intermediate latent code may represent a data representation (e.g., a vector) comprising a plurality of entries (e.g., values).

The interpolation block 262 may interpolate (e.g., linearly interpolate) between the two intermediate latent codes 258-260 to obtain interpolated intermediate latent codes (e.g., five interpolated intermediate latent codes). Subsequently, each of the intermediate latent codes (e.g., the first and second intermediate latent codes 258-260 as well as the interpolated intermediate latent codes) may be provided to the generation process 264. The generation process 264 may process the intermediate latent codes to generate synthetic human representations 266. For example, for each intermediate latent code (e.g., the seven intermediate latent codes), the generation process 264 may generate a synthetic human representation (e.g., an image or avatar of a human). Furthermore, due to the linear interpolation of the intermediate latent space, synthetic human representations of the interpolated intermediate latent codes may represent linear changes, modifications, and/or alterations from the synthetic human representation of the first intermediate latent code 258 to the synthetic human representation of the second intermediate latent code 260.

For instance, taking a simplified example, the first synthetic human representation associated with the first intermediate latent code 258 may represent a human wearing a dark blue shirt and the second synthetic human representation associated with the second intermediate latent code 260 may represent the same human wearing a white shirt. The synthetic human representations of the interpolated intermediate latent codes may represent a linear color change from the dark blue shirt to the white shirt. For instance, the synthetic human representation of the interpolated intermediate latent code that is closest to the first intermediate latent code 258 may have the human wearing a dark blue shirt that is lighter in color than the dark blue shirt worn by the human from the first intermediate latent code 258. As such, each of the synthetic human representations of the interpolated intermediate latent codes may represent a human wearing a lighter and lighter blue colored shirt until reaching the completely white shirt of the synthetic human representation of the second intermediate latent code 260.

In an embodiment, the DHFM may be used to perform appearance editing. For example, based on adopting a UV-based representation, embodiments of the present disclosure may preserve the topology of the template mesh, which enables appearance editing through texture map modification. The process may begin by importing the UV map and mesh into an application. Next, embodiments of the present disclosure may map an image, such as an image with a logo, to the corresponding UV regions through projective texture mapping, creating a new texture layer. During inference, embodiments of the present disclosure may additively blend the manually edited texture map with the one predicted by the generator, which allows for effective appearance modification. This is described in further detail in FIG. 2C.

FIG. 2C shows an appearance editing process 270 that uses the DHFM to generate synthetic human representations, in accordance with one or more embodiments of the present disclosure. The process 270 includes appearance editing inputs 272, the mapping network 280, the trained generator 282, the linear blend skinning and deformation block 288, the multi-part rendering block 290, and the synthetic human representation 292. Many of the aspects of the process 270 may be similar to the aspects described above such as the aspects described in FIG. 1B. For example, appearance editing inputs 272, the mapping network 280, and the trained generator 282 may be similar to the inputs 142, the mapping network 150, and the trained generator 152 described in FIG. 1B.

However, the output from the trained generator 282 may be modified, altered, and/or adjusted based on the appearance editing input 284. For example, as mentioned above, the user may seek to modify certain attributes such as adding a logo or facial hair on the synthetic human representation 292. As such, the user may provide appearance editing input 284 indicating the modifications. The compositing of textures block 286 may obtain the texel-aligned Gaussian maps generated by the trained generator 282 and the appearance editing input 284. Then, the compositing of textures block 286 may perform compositing of the textures (e.g., a mixing of the textures and/or features) to generate modified texel-aligned Gaussian maps. For instance, as mentioned above, the texel-aligned Gaussian maps may indicate feature parameters. The appearance editing input 284 may indicate modifications to the feature parameters (e.g., modifications indicating to add a logo or facial hair). The compositing of textures block 286 may perform compositing such as by combining visual elements from the texel-aligned Gaussian maps (e.g., the feature parameters) and the visual elements from the appearance editing input 284 to generate modified texel-aligned Gaussian maps (e.g., texel-aligned Gaussian maps with modified feature parameters).

Subsequently, the linear blend skinning and deformation block 288 and the multi-part rendering block 290 may use the modified texel-aligned Gaussian maps and/or the inputs 272 to generate a synthetic human representation 292. The generated synthetic human representation 292 may be a human representation that includes the modifications indicated by the appearance editing input 284. For instance, the shirt of the human representation may include a logo and/or the human may have facial hair.

Among other benefits and advantages, embodiments of the present disclosure provide a DHFM that may include a mapping network and a generator that generates texel-aligned Gaussian maps, which are then used to generate synthetic human representations. Additionally, and/or alternatively, the DHFM further includes a linear blend skinning and deformation block that performs conical constraints to constrain the offsets of the position and rotation parameters of the texel-aligned Gaussian maps. Additionally, and/or alternatively, the DHFM further includes multiple discriminators (e.g., the full body discriminator 118, the face discriminator 120, and the hand discriminator 122) that generates discriminator outputs. The discriminator outputs may be generated based on the training inputs and the rendered image from the multi-part rendering block 116. In some instances, one or more of the discriminators may receive only a portion of the training inputs and/or the rendered image. For example, the face discriminator 120 may generate a discriminator output based on a portion of the pose information 104 (e.g., facial features of the pose information 104) and a portion of the rendered image (e.g., a cropped version of the rendered image showing only the face of the human). Similarly, the hand discriminator 122 may generate a discriminator output based on a portion of the pose information 104 (e.g., the hand poses from the pose information 104) and a portion of the rendered image (e.g., a cropped version of the rendered image showing only the hands of the human). Additionally, and/or alternatively, the DHFM may be trained using a plurality of losses including, but not limited to, an adversarial loss, a Gaussian position regularization loss [symbol] , a Gaussian scale regularization loss [symbol] , and/or a Gaussian opacity regularization loss [symbol] . Additionally, and/or alternatively, the DHFM may be further fine-tuned for one-shot generation using two phases. For example, in the first phase, the intermediate latent space may be trained based on a reconstruction loss. In the second phase, the generator 214 may be further fine-tuned using the reconstruction loss. Additionally, and/or alternatively, the DHFM may be used in a variety of applications including, but not limited to, random synthetic human representation generation, latent space interpolation generation, and/or appearance editing.

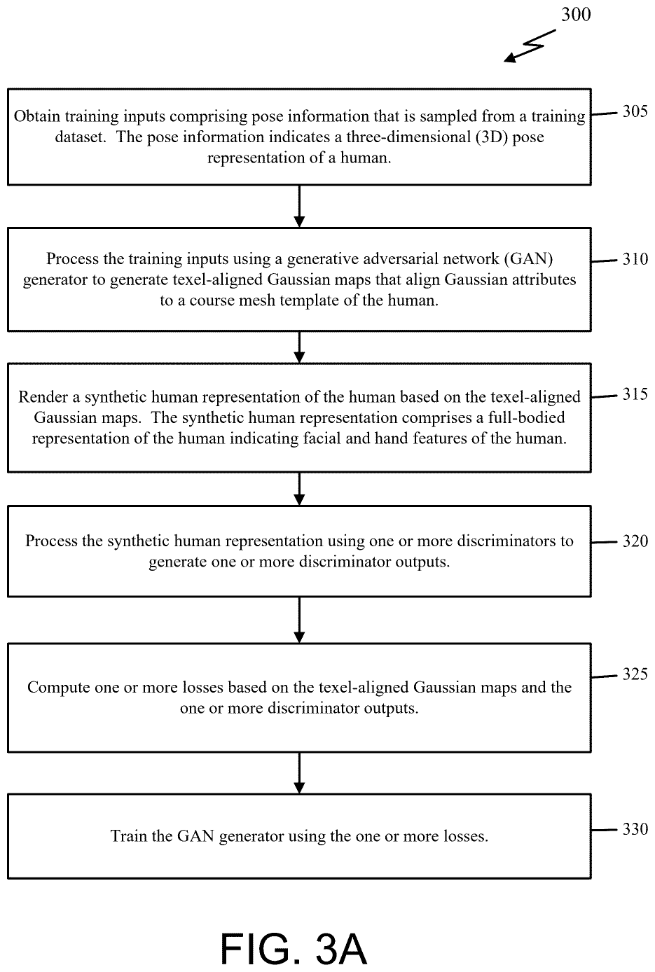

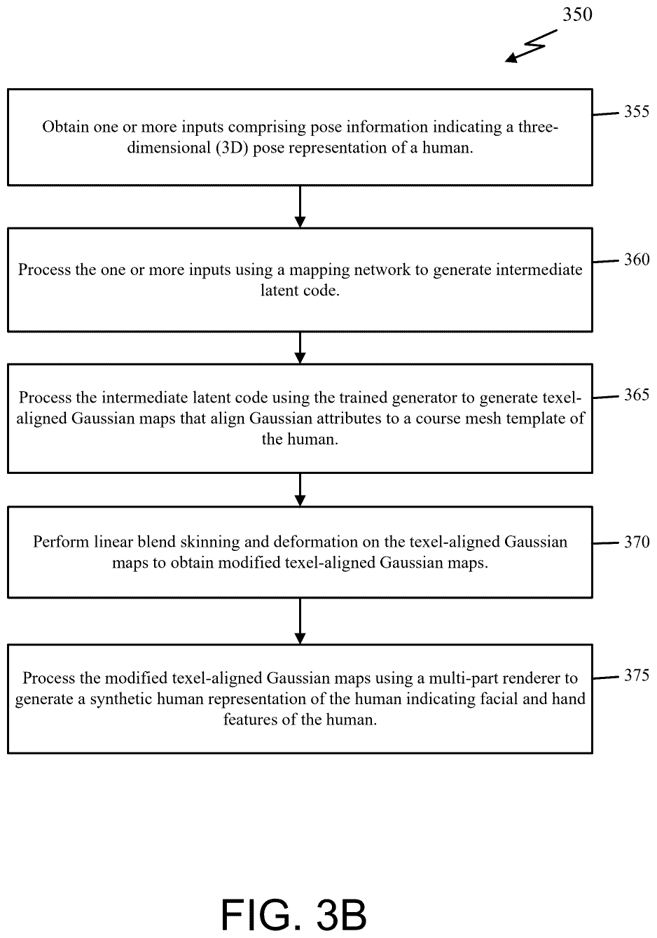

FIG. 3A illustrates a flowchart of a method 300 for training a digital human foundational model (DHFM) comprising a generative adversarial network (GAN) generator, in accordance with one or more embodiments of the present disclosure. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the training process 100 of FIG. 1A. However, the method 300 may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 305, training inputs comprising pose information that is sampled from a training dataset are obtained. The pose information indicates a three-dimensional (3D) pose representation of a human.

At step 310, the training inputs are processed using the GAN generator to generate texel-aligned Gaussian maps that align the Gaussian attributes to a coarse mesh template of the human. In an embodiment, the training inputs further comprise camera information indicating a camera pose and appearance and geometry information indicating a latent code and processing the training inputs comprises: processing the pose information, the latent code, and the camera information using a mapping network to generate intermediate latent code; and processing the intermediate latent code using the GAN generator to generate the texel-aligned Gaussian maps.

At step 315, a synthetic human representation of the human is rendered based on the texel-aligned Gaussian maps. The synthetic human representation comprises a full-bodied representation of the human indicating facial and hand features of the human. In an embodiment, rendering the synthetic human representation of the human based on the texel-aligned Gaussian maps comprises: performing linear blend skinning and deformation of the texel-aligned Gaussian maps to obtain modified texel-aligned Gaussian maps; and processing the modified texel-aligned Gaussian maps using a 3D Gaussian Splatting (3DGS) renderer to render the synthetic human representation of the human. In an embodiment, performing the linear blend skinning and deformation of the texel-aligned Gaussian maps comprises: rotating vectors indicating joints and connectors associated with the joints based on the 3D pose information; aligning the coarse mesh template of the human from a default position to a new position that is based on rotating the vectors; and obtaining the modified texel-aligned Gaussian maps based on aligning the coarse mesh template to the new position.

In an embodiment, obtaining the modified texel-aligned Gaussian maps comprises: changing positions of the Gaussian attributes from the texel-aligned Gaussian maps to the new position; and subsequent to changing the positions of the Gaussian attributes, performing tangent space Gaussian motion and cone regularization of the texel-aligned Gaussian maps to obtain the modified texel-aligned Gaussian maps. In an embodiment, the texel-aligned Gaussian maps comprise position offsets and rotation offsets, and performing the cone regularization comprises: scaling the positional offsets by a first factor to reduce degrees of freedom for the positional offsets; applying a constraint to the scaled positional offsets to generate cone constrained position offsets; and updating global Gaussian positions for the Gaussian attributes based on the cone constrained position offsets.

At step 320, the synthetic human representation is processed using one or more discriminators to generate one or more discriminator outputs. In an embodiment, the one or more discriminators comprises a full-body discriminator, a hand discriminator, and a face discriminator. Further, processing the synthetic human representation using the one or more discriminators to generate the one or more discriminator outputs comprises: cropping the synthetic human representation using a first bounding box and a second bounding box to generate a first cropped image of a hand of the synthetic human representation and a second cropped image of a face of the synthetic human representation; generating a full-body discriminator output based on the full-body discriminator processing the synthetic human representation; generating a hand discriminator output based on the hand discriminator processing the first cropped image of the hand of the synthetic human representation; and generating a face discriminator output based on the face discriminator processing the second cropped image of the face of the synthetic human representation.

At step 325, one or more losses are computed based on the texel-aligned Gaussian maps and the one or more discriminator outputs. In an embodiment, the one or more losses comprises a Gaussian scale regularization loss, a Gaussian opacity regularization loss, a Gaussian position regularization loss, and an adversarial loss. In an embodiment, the one or more discriminators comprises a full-body discriminator, a hand discriminator, and a face discriminator, and the adversarial loss comprises a first loss associated with the full-body discriminator, a second loss associated with the hand discriminator, and a third loss associated with the face discriminator.

At step 330, the GAN generator is trained using the one or more losses.

In an embodiment, the method 300 further comprises: subsequent to training the GAN generator, obtaining inference inputs; using the trained generator and the inference inputs to generate inference texel-aligned Gaussian maps; and rendering an inference synthetic human representation based on the inference texel-aligned maps.

In an embodiment, at least one of steps 305-330 and/or the further steps described above for method 300 are performed on a server or in a data center. In an embodiment, at least one of steps 305-330 and/or the further steps described above for method 300 is performed within a cloud computing environment. In an embodiment, at least one of steps 305-330 and/or the further steps described above for method 300 is performed for training, testing, or certifying a neural network employed in a machine, robot, or autonomous vehicle. In an embodiment, at least one of steps 305-330 and/or the further steps described above for method 300 is performed on a virtual machine comprising a portion of a graphics processing unit.

FIG. 3B illustrates a flowchart of a method 350 for using a digital human foundational model (DHFM) comprising a generative adversarial network (GAN) generator, in accordance with one or more embodiments of the present disclosure. Each block of method 350, described herein, comprises a computing process that may be performed using any combination of hardware, firmware, and/or software. For instance, various functions may be carried out by a processor executing instructions stored in memory. The method 350 may also be embodied as computer-usable instructions stored on computer storage media. The method 350 may be provided by a standalone application, a service or hosted service (standalone or in combination with another hosted service), or a plug-in to another product, to name a few. In addition, method 350 is described, by way of example, with respect to the aspects from FIG. 1B and FIGS. 2A-2C. However, the method 350 may additionally or alternatively be executed by any one system, or any combination of systems, including, but not limited to, those described herein. Furthermore, persons of ordinary skill in the art will understand that any system that performs method 350 is within the scope and spirit of embodiments of the present disclosure.

At step 355, one or more inputs comprising pose information indicating a three-dimensional (3D) pose representation of a human is obtained. At step 360, the one or more inputs are processed using a mapping network to generate intermediate latent code. At step 365, the intermediate latent code is processed using the trained generator to generate texel-aligned Gaussian maps that align Gaussian attributes to a coarse mesh template of the human. At step 370, linear blend skinning and deformation on the texel-aligned Gaussian maps is performed to obtain modified texel-aligned Gaussian maps. At step 375, the modified texel-aligned Gaussian maps are processed using a multi-part renderer to generate a synthetic human representation of the human indicating facial and hand features of the human.

In an embodiment, method 350 further comprises: prior to processing the one or more inputs using the mapping network and processing the intermediate latent code using the trained generator, training the DHFM comprising the mapping network and the generator using a training dataset. In an embodiment, method 350 further comprises: subsequent to training the generator using the training dataset, performing further training of the DHFM, wherein performing further training of the DHFM comprises: optimizing an intermediate latent space associated with the mapping network during a first phase; and fine-tuning parameters of the generator during a second phase. In an embodiment, optimizing the intermediate latent space comprises: performing a first number of iterations using the DHFM to determine training synthetic human representations; determining reconstruction losses for each of the first number of iterations based on the training synthetic human representations; and optimizing the intermediate latent space based on the reconstruction losses. In an embodiment, fine-tuning the parameters of the generator comprises: performing a second number of iterations using the DHFM to determine a second set of training synthetic human representations; determining a second set of reconstruction losses for each of the second number of iterations based on the second set of training synthetic human representations; and updating the parameters of the generator based on the second set of reconstruction losses.

In an embodiment, the one or more inputs further comprises second pose information indicating a second 3D pose representation of a second human, processing the one or more inputs using the mapping network to generate the intermediate latent code comprises processing the one or more inputs using the mapping network to generate a first intermediate latent code for the pose information indicating the 3D pose representation of the human and a second intermediate latent code for the second pose information indicating the second 3D pose representation of the second human, and generating the synthetic human representation of the human comprises generating a plurality of synthetic human representations of the human based on the first intermediate latent code and the second intermediate latent code.

In an embodiment, the method 350 further comprises: interpolating between the first intermediate latent code and the second intermediate latent code to determine a plurality of intermediate latent codes, wherein the plurality of intermediate latent codes comprises the first intermediate latent code, the second intermediate latent code, and one or more interpolated intermediate latent codes, and wherein the plurality of synthetic human representations that are generated comprises a first synthetic human representation associated with the first intermediate latent code, a second synthetic human representation associated with the second intermediate latent code, and one or more interpolated synthetic human representations associated with the one or more interpolated intermediate latent codes. In an embodiment, interpolating between the first intermediate latent code and the second intermediate latent code to determine the plurality of intermediate latent codes comprises: linearly interpolating between the first intermediate latent code and the second intermediate latent code to determine the one or more interpolated intermediate latent codes.

In an embodiment, the method 350 further comprises: obtaining appearance editing input indicating one or more modifications for the synthetic human representation, and wherein performing the linear blend skinning and deformation on the texel-aligned Gaussian maps to obtain the modified texel-aligned Gaussian maps comprises: compositing textures from the appearance editing input with the texel-aligned Gaussian maps to obtain composite texel-aligned Gaussian maps; and performing the linear blend skinning and deformation on the texel-aligned Gaussian maps on the composite texel-aligned Gaussian maps to obtain the modified texel-aligned Gaussian maps.

In an embodiment, at least one of steps 355-375 and/or the further steps described above for method 350 are performed on a server or in a data center to generate the synthetic human representation, and the synthetic human representation is streamed to a user device. In an embodiment, at least one of steps 355-375 and/or the further steps described above for method 350 is performed within a cloud computing environment. In an embodiment, at least one of steps 355-375 and/or the further steps described above for method 350 is performed for training, testing, or certifying a neural network employed in a machine, robot, or autonomous vehicle. In an embodiment, at least one of steps 355-375 and/or the further steps described above for method 350 is performed on a virtual machine comprising a portion of a graphics processing unit.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

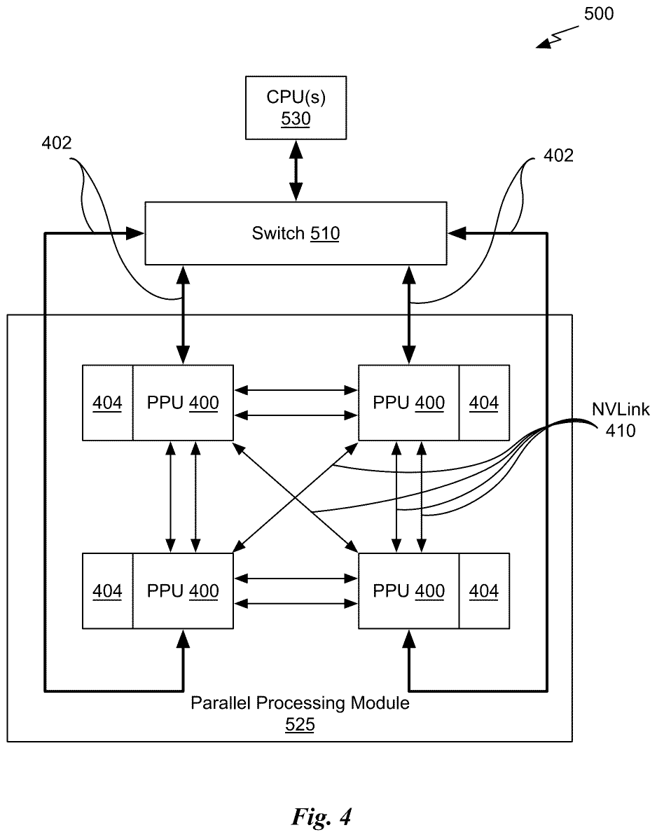

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

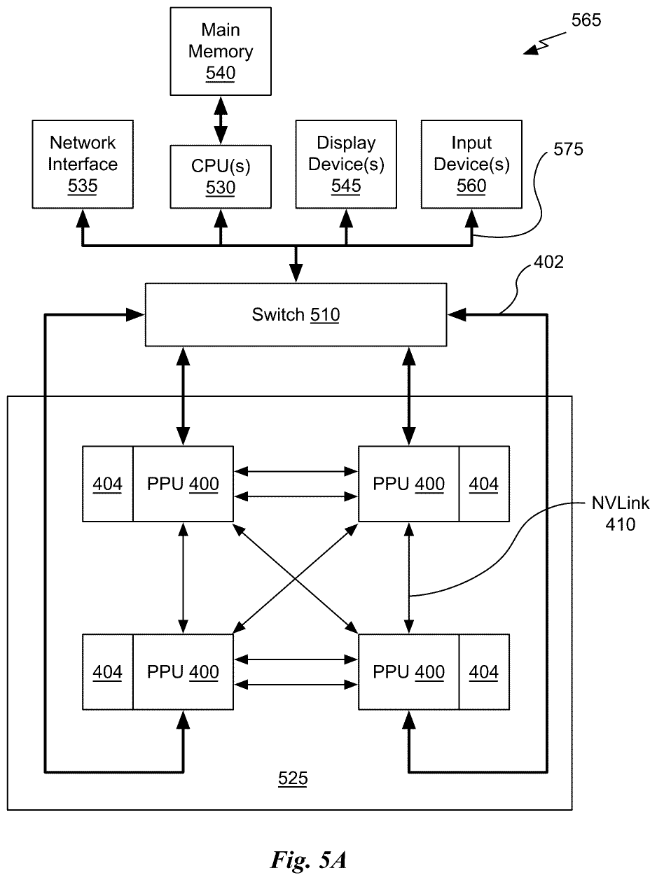

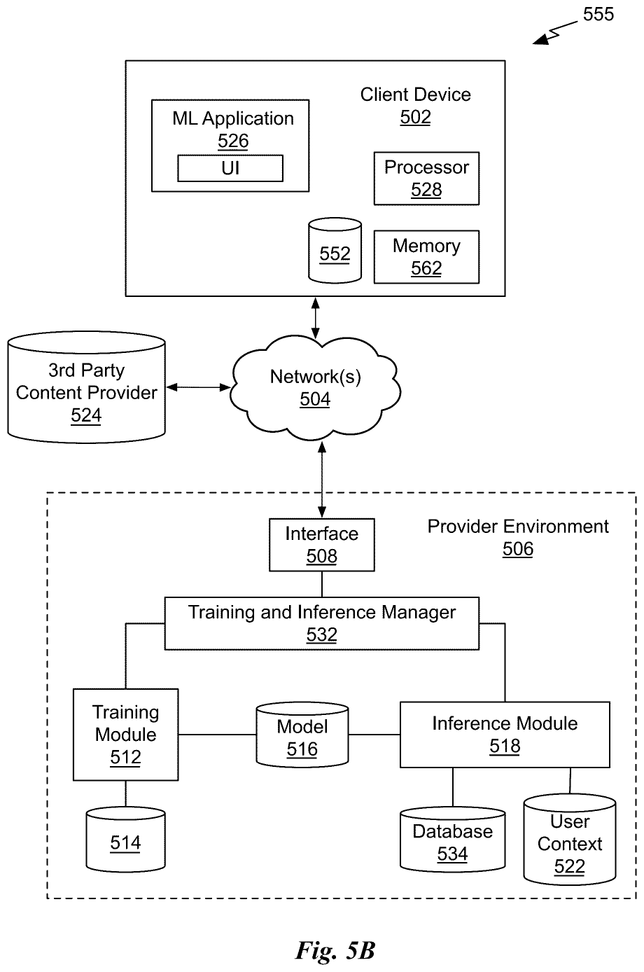

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

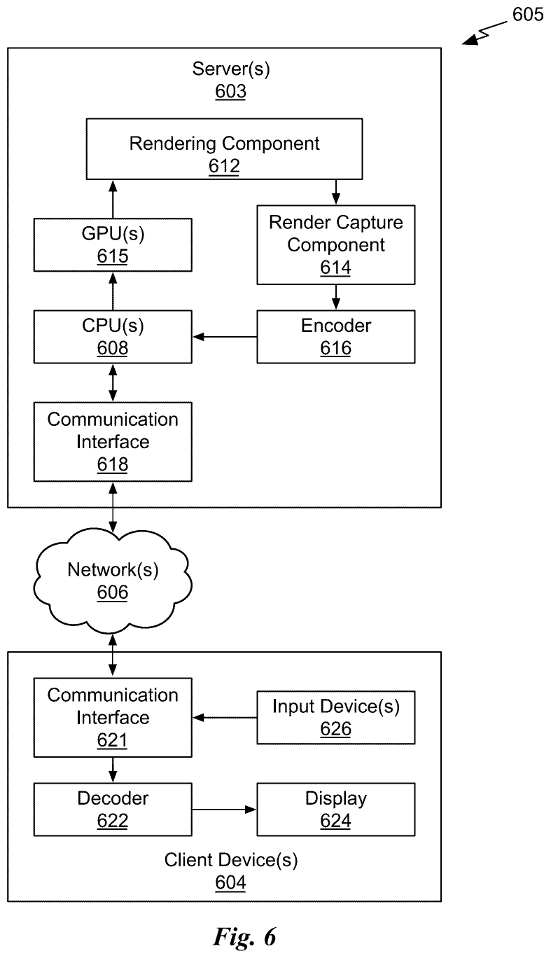

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

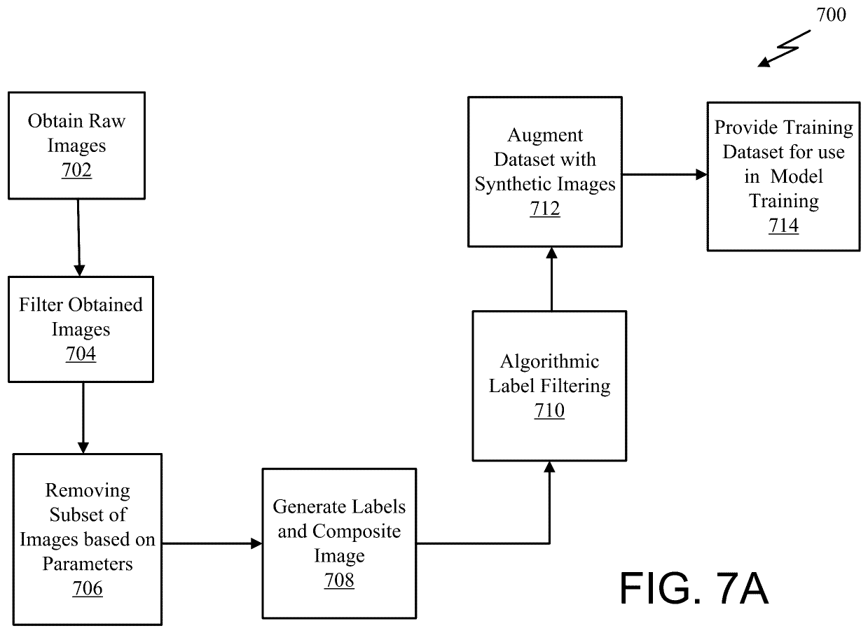

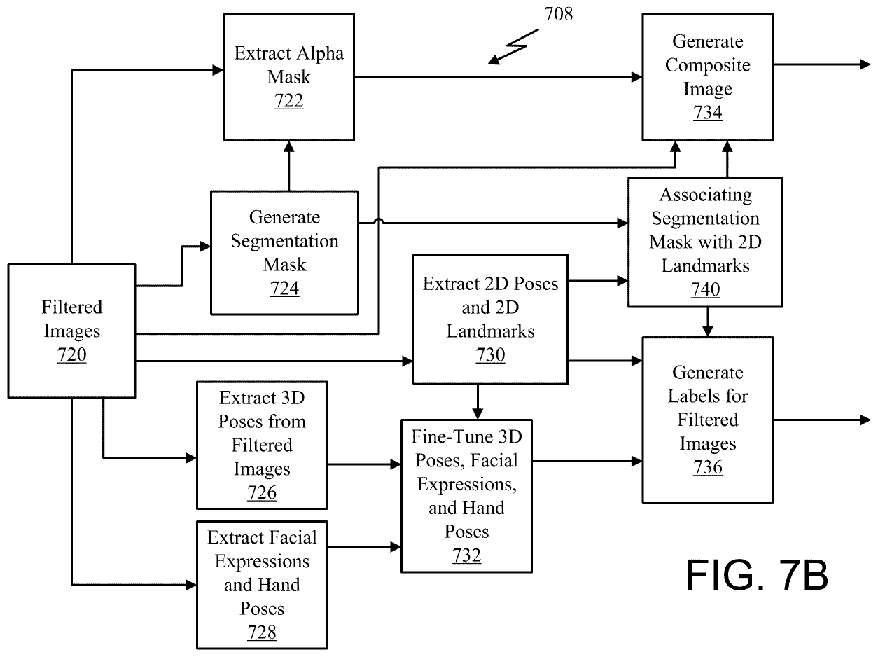

As mentioned previously, the DHFM may be trained using a large-scale dataset such as a large “in-the-wild” training dataset that includes “in-the-wild” and/or synthetic images. In some examples, to generate the large-scale dataset, embodiments of the present disclosure may curate “in-the-wild” images and/or generate synthetic images to augment the curated “in-the-wild” images. This is described in further detail in FIGS. 7A and 7B.

FIGS. 7A and 7B show a data curation process 700 to generate the large-scale “in-the-wild” training dataset, in accordance with one or more embodiments of the present disclosure. FIG. 7A shows a data curation process 700 to generate the large-scale “in-the-wild” training dataset. In operation, at block 702, embodiments of the present disclosure may obtain raw images. For example, initially, raw images such as “in-the-wild” images may be obtained. “In-the-wild” may refer to uncontrolled imagery, which may be opposed to images taken in lab environments or pose pictures (e.g., driver's license/passport images). The “in-the-wild” images may further show humans, animals, items, and/or other objects of interest. The data curation process 700 may obtain the “in-the-wild” images from one or more data sources such as one or more databases that include the “in-the-wild” images. The data curation process 700 may store the “in-the-wild” images within a training dataset. Then, as will be described below, the data curation process 700 may generate additional information (e.g., labels, composite images, and/or other information described below)) associated with the “in-the-wild” images and/or filter/remove subsets of “in-the-wild” images from the training dataset.

In some examples, the data curation process 700 may generate and/or create proxies of the obtained raw images (e.g., the “in-the-wild” images). For example, the raw images may have a first resolution (e.g., a native image size) such as 4096×4096 pixels, but the data curation process 700 might not require such a high resolution. As such, the data curation process 700 may perform one or more algorithms (e.g., a downsampling algorithm) to generate proxy images that are at a second resolution, which is less than the first resolution (e.g., if the first resolution is 4096×4096, the second resolution may be 1024×1024, 512×512, or 256×256). The generation and/or creation of proxies is optional and the data curation process 700 may or might not perform this step.

After obtaining the raw images and/or the proxy images, the data curation process 700 may filter the obtained images using blocks 704 and 706 to obtain filtered images that are then provided to block 708. For example, the data curation process 700 may perform block 704 to filter the images using one or more criteria. For example, as described above, the DFHM may be used to generate full-bodied synthetic humans. As such, the data curation process 700 may filter the images (e.g., the raw and/or proxy images) based on a criteria that the image includes at least one human. Additionally, and/or alternatively, at block 706, the data curation process 700 may remove a subset of images of humans from the training dataset based on one or more parameters. For example, the raw images may show humans, but the humans may be a cartoon or animated version of humans, which might not be useful for training the DFHM. In some instances, the raw images may show a human, but may be of poor quality that causes difficulties when training the DFHM. As such, based on one or more parameters (e.g., parameters associated with the image showing a human and/or parameters associated with the image quality such as image quality metric and/or parameters), the data curation process 700 may determine a subset of images and may remove the subset of images. Thus, based on performing blocks 704 and 706, the data curation process 700 may obtain filtered images (e.g., images that show one or more actual humans and have an image quality metric that is above one or more thresholds). To put it another way, based on performing blocks 704 and 706, the data curation process 700 may perform an initial curation process (e.g., filtering and/or removing process) to remove one or more “in-the-wild” images from the training dataset. The remaining images within the training dataset may be the “filtered images” described below, and the data curation process 700 may generate additional information (e.g., labels and/or composite images) for the filtered images.

Block 708 may use the filtered images to generate labels and/or composite images. This is described in FIG. 7B. For example, referring to FIG. 7B, the filtered images 720 from the blocks 704 and 706 may be obtained. The filtered images 720 may be used by blocks 722-730 for composite image generation (e.g., block 734) and for label generation (e.g., block 736). For example, initially, blocks 724 and 730 may be performed to generate the segmentation mask and extract 2D poses and 2D landmarks. For example, at block 724, the data curation process 700 may process the filtered images 720 (e.g., each filtered image) to generate a segmentation mask. In some examples, at block 724, the data curation process 700 may use panoptic segmentation and/or entity separation. When using panoptic segmentation, the same type of entity (e.g., human) may be labeled with different colors. For instance, based on performing blocks 704 and/or 706, actual humans may be identified. In some examples, the data curation process 700 may perform instant segmentation (e.g., separate colors are assigned to different humans). For instance, at block 724, a bounding box and label may be assigned to each human within the image. Taking an example of an image with two humans and a car, a first bounding box that has a first color (e.g., dark blue) may be assigned to the first human, a second bounding box that has a second color (e.g., teal) may be assigned to the second human, and a third bounding box that has a third color (e.g., pink) may be assigned to the third human. In a second image with a first human, the first human may still be assigned to the first color (e.g., dark blue).

At block 730, the data curation process 700 may extract 2D poses and 2D landmarks. For example, the data curation process 700 may perform one or more 2D extraction algorithms and/or processes (e.g., a 2D landmark extraction method that may be configured to obtain the Microsoft Common Objects in Context Dataset (MSCOCO) keypoints) to obtain the 2D poses and/or 2D landmarks (e.g., extract the 2D poses and/or 2D landmarks from the filtered image). For instance, the filtered image may show two humans. For each human, the 2D algorithms and/or processes may determine a plurality of keypoints (e.g., 133 keypoints including 17 body keypoints, 6 keypoints for the feet, 68 keypoints for the face, and 42 keypoints for the hands), which may indicate the 2D pose and/or 2D landmark associated with the human. The 2D landmark extraction method that is described above to determine the 2D poses and/or 2D landmarks (e.g., the MSCOCO keypoints) is merely exemplary and the data curation process 700 may use any type of neural network and/or other type of 2D algorithms and/or processes to obtain the 2D poses and/or 2D landmarks associated with the filtered images.

In some examples, each of the 2D landmarks that are generated based on the 2D extraction algorithms and/or processes may further be associated with a confidence value indicating whether the 2D landmark is occluded. For example, if the image shows a hand covering a knee of the human, the 2D extraction algorithm may generate a 2D landmark associated with the knee and a 2D landmark associated with the hand. The 2D extraction algorithm may further generate a confidence value for the knee and another confidence value for the hand. The confidence value for the knee may be less than the confidence value for the hand, which may indicate that the knee is occluded within the image.

At block 740, the data curation process 700 may associate the segmentation mask with the 2D landmarks. For example, after obtaining the segmentation mask from block 724 and the extracted 2D poses and/or 2D landmarks from block 730, the data curation process 700 may perform a process and/or algorithm (e.g., a non-Maximal Suppression (NMS) algorithm and/or other types of matching-based algorithms) to determine the correlation between the two blocks 724 and 730. For instance, the segmentation mask from block 724 and the 2D poses and/or 2D landmarks from block 730 may be obtained using separate algorithms and/or processes. As such, at block 740, a further process and/or algorithm (e.g., the NMS algorithm) may be used to combine, associate, correlate and/or otherwise connect the two outputs from blocks 724 and 730. In some variations, the output from block 740 may be an index. For instance, in the previous blocks 724 and 730, the segmentation mask and the 2D landmarks may be obtained, and may be in one or more data formats (e.g., files). For instance, the 2D landmarks may be a list that is in JAVASCRIPT Object Notation (JSON) and the segmentation masks may be in another data format. At block 740, the 2D landmarks may be associated with the segmentation mask such that a list of points from the 2D landmarks are associated with a specific color portion of the segmentation mask. At block 740, an index may be generated to associate the list of points from the 2D landmarks with the segmentation mask(s).

In some examples, after correlating the segmentation mask from block 724 and the 2D poses and/or 2D landmarks from block 730, the data curation process 700 may determine one or more statistical quality scores and/or other features associated with the image. For example, the data curation process 700 may determine a joint visibility score (e.g., each image may be labeled for composition size such as ¼, ½, ¾, and/or full body). For instance, ¼ composition size may indicate that only ¼ of the human is visible (e.g., the hands, neck, and face of the human) whereas a full body composition size may indicate that the entire human is visible from the head to the feet and hands.

Further, the data curation process 700 may determine whether the hands occlude the face. For example, based on the correlated segmentation mask and the 2D poses/2D landmark, the data curation process 700 may determine whether the hands are occluding a portion or the entire face of the human. In addition, the data curation process 700 may determine statistical quality scores such as a polygon boundary intersection over union (IoU) between humans, an occlusion score, and/or a coverage score. For example, the occlusion score and the coverage score may be determined based on the below expressions:

$$OcclusionScore = \frac{Area ( Polygon ) - Area ( Polygon ⋂ ObjectBoxes )}{Area ( Polygon )}$$

$$CoverageScore = \frac{Area ( Human )}{Area ( Image )}$$

In addition to using the filtered images 720 to generate segmentation masks and extract 2D poses and 2D landmarks, the data curation process 700 may further perform blocks 726 and 728 to extract 3D poses from the filtered images and to extract facial expressions and hand poses. For example, while block 730 extracted 2D poses and 2D landmarks that are in a 2D space, the data curation process 700 may perform one or more 3D extraction algorithms and/or processes to extract 3D poses from the filtered images. The extracted 3D poses may be in a 3D space (e.g., may have x, y, and z coordinates) whereas the extracted 2D poses and landmarks may be in a 2D space (e.g., may have x and y coordinates). In some examples, the data curation process 700 may use a 3D pose estimator such as the one-stage pipeline for expressive whole-body (body, face, and hand) mesh recovery (OSX) process to extract the 3D poses from the filtered image. For instance, the 3D pose estimator (e.g., OSX) may process the filtered images to predict a 3D pose (e.g., a 3D estimated pose) of the human within the filtered images. The 3D pose estimator may further provide the global orientation and/or 3D coordinates (e.g., x, y, and z coordinates) that are relative to the camera parameters (e.g., the camera coordinates). Subsequently, the data curation process 700 may modify the SMPL-X neutral pose mesh (e.g., the mesh of the human in a default position such as a T-pose) based on the 3D estimated pose from the 3D pose estimator. As such, the data curation process 700 may obtain 3D poses (e.g., a 3D representation of the human) that are in a SMPL-X data format, which is described previously. Using the OSX as the 3D pose estimator and using the SMPL-X data format are merely exemplary and the data curation process 700 may use any type of 3D pose estimator and/or data format.

In some examples, based on obtaining the 3D poses for the filtered images, the data curation process 700 may measure the pose diversity. For instance, the data curation process 700 may determine the pose distribution for the 3D poses (e.g., the yaw or roll angles associated with the 3D poses). Additionally, and/or alternatively, the data curation process 700 may determine and/or fetch specific poses, bias the curator/sampler to equalize the pose distribution, and/or acquire/generate additional images.

At block 728, the data curation process 700 may extract facial expressions and/or hand poses from the filtered image. For example, the data curation process 700 may use one or more facial expression extraction algorithms and/or processes to extract the facial expressions and/or shapes for the human(s) within the filtered image. The extracted facial expressions and/or shapes may be in the Faces Learned with an Articulated Model and Expression (FLAME) representation. In addition, the data curation process 700 may extract the hand poses from the filtered image. For instance, the data curation process 700 may extract face shapes, expression, pose, and/or feature colors for the human(s) within the filtered image. In some instances, first, the data curation process 700 may detect the face of the human within the image and crop the image to show the face. Subsequently, the data curation process 700 may process the cropped image of the face to extract the expression. The output from block 728 may include the expression vector, head pose, and/or camera parameters associated with the filtered image. The FLAME representation is merely exemplary and the data curation process 700 may use any extraction algorithm and/or process to extract facial expressions in any facial representation and/or hand poses in any hand representation.

At block 732, the 3D poses, facial expression, and/or hand poses that were generated using blocks 726 and 728 may be fine-tuned based on the extracted 2D poses and 2D landmarks from block 730. For example, given that the 3D poses, facial expressions, and hand poses are generated using different algorithms than the 2D poses and 2D landmarks, the data curation process 700 may use the 2D poses and 2D landmarks to fine-tune or curate the 3D poses, facial expressions, and hand poses. In other words, the data curation process 700 may be configured to encourage the 3D poses, facial expressions, and hand poses to fit closer to the 2D points. For example, the data curation process 700 may project the keypoints from the 3D poses onto the 2D space based on using a camera projection equation. For instance, based on the camera coordinates (e.g., the camera coordinates that are predicted using the 3D pose estimator), the 3D poses (e.g., the vector indicating the predicted 3D poses from the 3D pose estimator) may be projected onto 2D space. Subsequently, the data curation process 700 may compare the projected 3D poses on the 2D space with the 2D poses and 2D landmarks from block 730. Based on the comparison, the data curation process 700 may modify and/or adjust the 3D poses, facial expressions, and/or hand poses.

Furthermore, at block 722, the data curation process 700 may extract an alpha mask for the filtered image. For instance, whereas the segmentation mask may indicate a binary value (e.g., “0” or “1) indicating whether an object (e.g., a human) is detected for the pixel, the alpha mask may indicate non-binary values (e.g., values between “0” and “1”). For example, the filtered image may include a human with hair. The alpha mask may indicate that the head of the human has a value of “1”, but may indicate that the hair of the human is a value between “0” and “1” (e.g., indicating a value of “0.8”). In some examples, the data curation process 700 may use an alpha mask algorithm such as, but not limited to, a bilateral reference for high-resolution dichotomous image segmentation (BiRefNet) algorithm to process the filtered image and generate the alpha mask.

In some instances, the data curation process 700 may use the generated segmentation mask from block 724 to generate the alpha mask. For example, an alpha mask generator may be used to generate an alpha mask (e.g., an initial alpha mask). However, solely using the generated alpha mask from the alpha mask generator may create issues as the alpha mask may leak (e.g., if a human is wearing a yellow shirt and in front of a yellow wall or if there are other objects behind the human, the alpha mask by itself may be unable to distinguish between the yellow shirt, the yellow wall, or the objects behind the human). As such, the segmentation mask may be used as a constraint to the alpha mask to obtain a constrained alpha mask. For instance, the alpha mask that is generated from the alpha mask generator may be constrained using the segmentation mask to ensure that the yellow shirt of the human is separated from the yellow wall (e.g., pixels associated with the yellow shirt are separated from the pixels associated with the yellow wall). By constraining the alpha mask using the segmentation mask, this may allow for a higher quality, fine-grained alpha mask that avoids the leak issues of alpha mask.

Following, the data curation process 700 may generate a composite image and the composite image may show only the human (e.g., the background from the filtered image may be omitted/not shown). For example, based on the filtered image, the extracted alpha mask from block 722, and/or the output from block 740 (e.g., the association between the segmentation mask and the 2D landmarks), the data curation process 700 may generate a composite image for the filtered image. For instance, as mentioned above, the alpha mask may represent the human from the image, but may further include other features of the image due to leaking. Thus, the segmentation mask from block 724 may be used to constrain the alpha mask, and the constrained alpha mask may be provided to the block 734. In addition, the filtered image 720 may also be provided to the block 734. Based on the filtered image 720, the constrained alpha mask, and the segmentation mask, a composite image may be generated, which may indicate the finer details of the filtered image 720 (e.g., everything from the filtered image 720 may be removed except for the human). In some instances, the three images (e.g., the constrained alpha mask, the filtered image 720, and the segmentation mask) may be multiplied together to generate the composite image. In some variations, instead of directly using the segmentation mask from block 724, the segmentation mask may first be isolated, dilated, and/or blurred. For instance, to allow for a better quality composite image, the pixels of the segmentation mask may be isolated, dilated and/or blurred together to generate a modified segmentation mask. The modified segmentation mask may be used with the constrained alpha mask and the filtered image 720 to generate the composite image. At block 736, the data curation process 700 may generate labels for the filtered images. For example, the labels for the filtered images may include the fine-tuned 3D poses, facial expressions, and hand poses from block 732 (e.g., the 3D pose representation that is described above), the extracted 2D poses and 2D landmarks from block 730, and the output from block 740 (e.g., the bounding polygon along with the keypoints).

In other words, in some embodiments, at block 708, the data curation process 700 may use a panoptic segmentation network to locate all instances of the “person” category in the raw images and each instance's segmentation may be further refined to a featured alpha mask. In addition, the data curation process 700 may generate labels including (a) whole-body 2D keypoints using one or more algorithms (e.g., the Real-Time Multi-Person Pose Estimation based on MMPose (RTMPose)); and 2) 3D pose representations (e.g., a SMPL-X 3D pose and shape representation using modified OSX wherein the 2D landmarks are used to further refine the OSX's predictions. In addition, the global orientation of each human with rest to the camera may be derived based on the SMPL-X labels.

Afterwards, returning back to FIG. 7A but prior to performing block 710 (e.g., performing the algorithmic label filtering), the data curation process 700 may utilize a vision language model (VLM). For example, the data curation process 700 may provide an image (e.g., the filtered image, the raw image, and/or the composite image) and a prompt to the VLM. The prompt may include a question about the image such as “is this a photograph?”, “is a human clearly visible in this image?”, “what is the gender or age of the human”, and/or “is this image of high quality by our definitions?” The VLM may process the image and the prompt and generate one or more responses to the inquiry. For example, the VLM may indicate that the human is not clearly visible from the image or that the image quality is of poor quality. Based on the responses, the data curation process 700 may determine whether to remove the image from the training dataset. For instance, if the VLM indicates that the human is not clearly visible in the image, the data curation process 700 may remove the image from the training dataset. In some examples, the data curation process 700 may utilize the VLM after generating the labels and the compositive image (e.g., block 708). In other instances, the data curation process 700 may utilize the VLM prior to performing block 708 and/or in parallel with performing block 708. In other words, the data curation process 700 may remove additional images from the training dataset based on using the VLM. The removal of the additional images using the VLM may be performed after block 708 (e.g., generating the labels and/or the composite images), in parallel with performing block 708, and/or prior to performing block 708.

Subsequently, the data curation process 700 may determine one or more metrics (e.g., statistical metrics) for the filtered images and use the one or more metrics to further curate the training dataset by filtering and/or removing additional images. For example, the data curation process 700 may perform a size and cropping test and/or an occlusion test to determine the metrics and further filter/remove the images from being included within the training dataset. For instance, as mentioned above, the data curation process 700 may determine statistical quality scores such as a polygon boundary IoU between humans (e.g., whether two humans are overlapping), an occlusion score (e.g., whether an object occludes the human), and/or a coverage score (e.g., how prominent the human is within the image). Based on these scores, the data curation process 700 may determine to filter and/or remove additional images from the training dataset. In some instances, one or more additional tests may be performed to filter and/or remove images from the training dataset. For instance, a hand coverage test may be performed where a first polygon may be drawn around the face and a second polygon may be drawn around the hand. Based on intersection between the first and second polygons, the image may be filtered and/or removed from the training dataset.

For example, given that the “in-the-wild” images might not include high-quality photoreal non-occluded full-body humans, that are fully visible in the image, the data curation process 700 may filter out many undesirable cases through an automated process. For example, as mentioned above, the data curation process 700 may eliminate low-quality non-photographic (e.g., vector graphic) images or those including blurry or out-of-focus faces by appropriately prompting a large VLM with a visual question answering task. In addition, using the algorithmic label filtering, the data curation process 700 may further remove: (a) very small humans (with area less than 8% of the image); (b) those with significant overlap (e.g., greater than or equal to 5%) with any other instances from the “thing” panoptic categories, and (c) those with occlusion of the face by hands by computing the overlap of the hand's 2D convex hull with that the of the face's using the detected 2D keypoints.

Additionally, and/or alternatively, the data curation process 700 may further restrict the training dataset to include only full-body humans that are fully visible in the image. For this, the data curation process 700 may determine instances where all of the whole-body 2D keypoints are visible with a high confidence (e.g., great than equal to 0.5) and “person” segmentation masks does not intersect significantly with the edge of the image.

In some examples, prior to performing blocks 712 and/or 714, the data curation process 700 may crop the images that remain within the training dataset after performing block 710. For instance, prior to using the “in-the-wild” images that are still within the training dataset for training of one or more machine learning—artificial intelligence (ML-AI) models, the data curation process 700 may crop the remaining images such that certain background features are removed. For example, given the ML-AI models (e.g., the DFHM) may use the images from the training dataset to generate synthetic humans, certain background features such as clouds or trees might not be necessary for the training. As such, the data curation process 700 may crop the images to omit such details from the images.

In other words, the data curation process 700 may crop the filtered images and masks above using the bounding box derived from SMPL-X parameters. The cropped images may be padded to square dimensions to ensure consistent input size and then resized to 512×512, preserving the aspect ratio via padding. Camera intrinsics, such as focal length f and principal point (cₓ, c_{y}), may be adjusted to align with the transformations applied during cropping and resizing.

At block 712, the data curation process 700 augments the dataset with synthetic images. For example, it was noticed that “in-the-wild” images typically include humans that are biased towards camera-facing human poses with very few of these images showing humans facing away from the camera. As such, to compensate for this factor, the data curation process 700 may use one or more models and/or algorithms to generate synthetic images. For example, the data curation process 700 may use a text-conditioned diffusion model designed for human image generation (e.g., a text-to-image foundation model) to generate the synthetic images showing humans. Additionally, and/or alternatively, the data curation process 700 may curate the synthetic images generated by the text-conditioned diffusion model prior to including the synthetic images within the training dataset.

At block 714, the data curation process 700 may provide the training dataset for use in model training. For instance, the training dataset may be generated based on the data curation process 700 such that the training dataset includes the “in-the-wild” images, information associated with the “in-the-wild” images such as the pose information 104 (e.g., the 3D pose representations indicating the 3D poses from the generated labels at block 708) and/or the camera information 106 (e.g., the camera parameters), the composite image, and/or other information. As such, the data curation process 700 may perform one or more techniques and/or algorithms to filter the “in-the-wild” images from the training dataset and only the images that satisfy the criteria, parameters, metrics, and/or other attributes may be included within the training dataset. For instance, the data curation process 700 may filter the “in-the-wild” images based on an indication that the image includes a human, one or more parameters (e.g., low image quality and/or that the image is an animation or cartoon), the response from the VLM, the metrics from the algorithmic label filtering, and/or other techniques described above. Afterwards, the data curation process 700 may generate synthetic images and augment the training dataset such that the training dataset includes the synthetic images and the images that satisfy the above criteria, parameters, metrics, and/or other attributes. Following, the training dataset may be used to train one or more models such as the DHFM described above.

In other words, to train a robust and generalizable 3D DHFM, a large collection of 2D full-body human images captured in the wild, with diversity of subject, pose, lighting, clothing, quality and camera viewpoints may be required. Many existing datasets are either too small, low-resolution, with limited poses, or are acquired in studio settings. This is because many were curated for virtual try on and hence include heavily curated studio-captured fashion images in limited body poses as opposed to “in-the-wild” images. To address quality, diversity and scale, embodiments of the present disclosure create a new large-scale training dataset of a plurality of high-quality “in-the-wild” full-body 2D photos, either sourced from professionally-produced collections of human captures in the wild or generated using state-of-the-art text-to-image diffusion models. The training dataset created by embodiments of the present disclosure may be one hundred times larger, of higher resolution, and include features significantly more diverse in terms of human attributes, including body pose, race, age, gender, headgear, hairstyles, clothing and lighting, and in terms of camera viewpoints, versus any conventional dataset.

Among other benefits and advantages, embodiments of the present disclosure provide a data curation process 700 that generates a large-scale “in-the-wild” training dataset comprising “in-the-wild” images. The data curation process 700 may curate subsets of “in-the-wild” images based on one or more parameters, criteria, metrics, and/or other factors. For example, the data curation process 700 may curate the “in-the-wild” images based on using one or more models (e.g., a large VLM), criteria (e.g., whether the image includes a human), parameters (e.g., whether the image is a photograph and/or whether the image has sufficient image quality), metrics (e.g., metrics associated with the algorithmic label filtering from block 710), and/or other factors. Additionally, and/or alternatively, the data curation process 700 may further generate a composite image and/or labels, which are described in block 708 and FIG. 7B. For example, the labels may include 2D poses and 2D landmarks, 3D poses that are fine-tuned based on the 2D poses and/or 2D landmarks, and the output from block 740 (e.g., a bounding polygon that is based on correlating the segmentation mask with the 2D poses and 2D landmarks. Additionally, and/or alternatively, the data curation process 700 may further augment the training dataset with synthetic images to provide the training dataset with additional poses (e.g., poses of humans that face away from the camera).

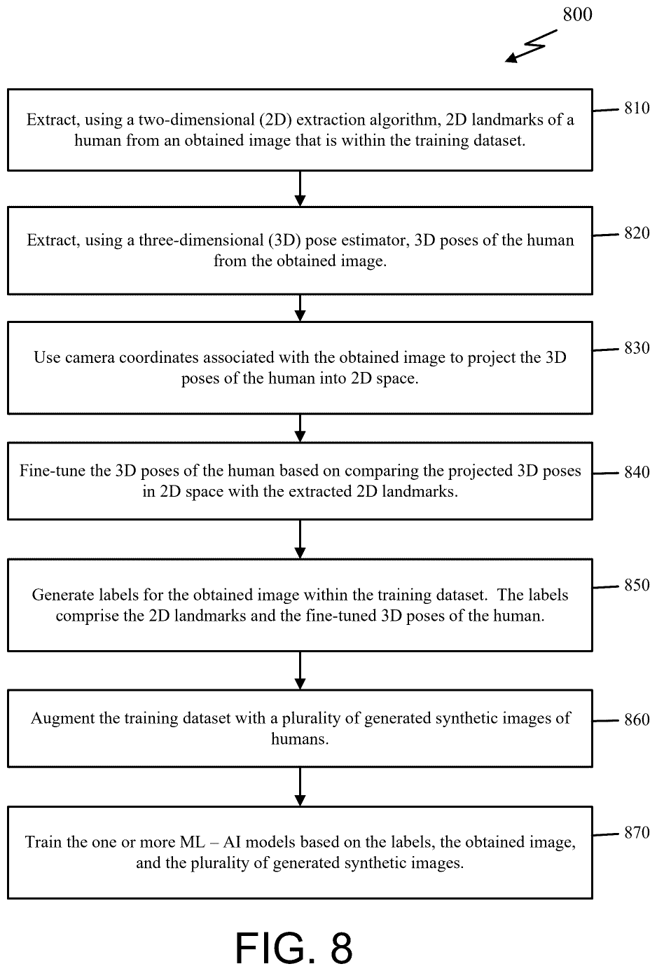

FIG. 8 illustrates a flowchart of a method 800 for generating and curating a training dataset for training one or more machine learning—artificial intelligence (ML-AI) models, in accordance with one or more embodiments of the present disclosure. Each block of method 800, described herein, comprises a computing process that may be performed using any combination of hardware, firmware, and/or software. For instance, various functions may be carried out by a processor executing instructions stored in memory. The method 800 may also be embodied as computer-usable instructions stored on computer storage media. The method 800 may be provided by a standalone application, a service or hosted service (standalone or in combination with another hosted service), or a plug-in to another product, to name a few. In addition, method 800 is described, by way of example, with respect to the aspects from FIGS. 7A and 7B. However, the method 800 may additionally or alternatively be executed by any one system, or any combination of systems, including, but not limited to, those described herein. Furthermore, persons of ordinary skill in the art will understand that any system that performs method 800 is within the scope and spirit of embodiments of the present disclosure.

At step 810, 2D landmarks of a human are extracted, using a 3D pose estimator, from the obtained image. At step 820, 3D poses of the human are extracted, using a 3D pose estimator, from the obtained image. At step 830, camera coordinates associated with the obtained image are used to project the 3D poses of the human into 2D space. At step 840, the 3D poses of the human are fine-tuned based on comparing the projected 3D poses in 2D space with the extracted 2D landmarks. At step 850, labels for the obtained image within the training dataset are generated. The labels comprise the 2D landmarks and the fine-tuned 3D poses of the human. At step 860, the training dataset are augmented with a plurality of generated synthetic images of humans. At step 870, the one or more ML-AI models are trained based on the labels, the obtained image, and the plurality of generated synthetic images.

In an embodiment, the method 800 further comprises: obtaining the training dataset comprising a plurality of raw images; and filtering the plurality of raw images from the training dataset to obtain filtered images based on removing a subset of raw images, wherein the obtained image is an image from the filtered images, and wherein filtering the plurality of raw images is based on a criteria that a raw image from the plurality of raw images shows at least one human and has an image quality above an image quality threshold.

In an embodiment, the method 800 further comprises: extracting a segmentation mask from the obtained image, wherein the segmentation mask indicates a binary value for each pixel of the obtained image representing whether the human is detected; extracting an alpha mask from the obtained image, wherein the alpha mask indicates a non-binary value for each pixel of the obtained image representing whether the human is detected; and generating a composite image based on the obtained image, the alpha mask, and the segmentation mask, wherein training the one or more ML-AI models is based on the composite image. In an embodiment, extracting the alpha mask from the obtained image comprises: generating an initial alpha mask based on an alpha mask generator processing the obtained image; and constraining the initial alpha mask based on the extracted segmentation mask to obtain a constrained alpha mask, and wherein generating the composite image is based on the constrained alpha mask. In an embodiment, generating the composite image comprises: dilating and blurring the segmentation mask to generate a modified segmentation mask; and generating the composite image based on multiplying the modified segmentation mask, the constrained alpha mask, and the obtained image.

In an embodiment, the method 800 further comprises: generating an index that associates the segmentation mask with the 2D landmarks, and wherein generating the labels for the obtained image is based on the index. In an embodiment, the training dataset comprises a plurality of images, and the method 800 further comprises: providing the plurality of images and a prompt to a vision language model (VLM) to generate vision outputs; and removing a subset of the plurality of images from the training dataset based on the vision outputs, wherein training the one or more ML-AI models is based on the training dataset after the subset of the plurality of images have been removed.

In an embodiment, the method 800 further comprises: determining a polygon boundary intersection over union (IoU) between humans, an occlusion score, and a coverage score for each of the plurality of images from the training dataset; and curating the training dataset by removing a second subset of the plurality of images based on the polygon boundary IoU between humans, the occlusion score, and the coverage score. In an embodiment, the method 800 further comprises: drawing first polygons around a face and second polygons around a hand for each of the plurality of images from the training dataset; based on intersections between the first polygons and the second polygons for each of the plurality of images, curating the training dataset by removing a third subset of the plurality of images.

In an embodiment, at least one of steps 810-870 and/or the further steps described above for method 800 are performed on a server or in a data center. In an embodiment, at least one of steps 810-870 and/or the further steps described above for method 800 is performed within a cloud computing environment. In an embodiment, at least one of steps 810-870 and/or the further steps described above for method 800 is performed for training, testing, or certifying a neural network employed in a machine, robot, or autonomous vehicle. In an embodiment, at least one of steps 810-870 and/or the further steps described above for method 800 is performed on a virtual machine comprising a portion of a graphics processing unit.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for using a digital human foundational model (DHFM) comprising a generative adversarial network (GAN) generator, comprising:
obtaining one or more inputs comprising pose information indicating a three-dimensional (3D) pose representation of a human;
processing the one or more inputs using a mapping network to generate intermediate latent code;
processing the intermediate latent code using the trained generator to generate texel-aligned Gaussian maps that align Gaussian attributes to a coarse mesh template of the human;
performing linear blend skinning and deformation on the texel-aligned Gaussian maps to obtain modified texel-aligned Gaussian maps;
processing the modified texel-aligned Gaussian maps using a multi-part renderer to generate a synthetic human representation of the human indicating facial and hand features of the human.

2. The computer-implemented method of claim 1, further comprising:
prior to processing the one or more inputs using the mapping network and processing the intermediate latent code using the trained generator, training the DHFM comprising the mapping network and the generator using a training dataset.

3. The computer-implemented method of claim 2, further comprising:
subsequent to training the generator using the training dataset, performing further training of the DHFM, wherein performing further training of the DHFM comprises:
optimizing an intermediate latent space associated with the mapping network during a first phase; and
fine-tuning parameters of the generator during a second phase.

4. The computer-implemented method of claim 3, wherein optimizing the intermediate latent space comprises:
performing a first number of iterations using the DHFM to determine training synthetic human representations;
determining reconstruction losses for each of the first number of iterations based on the training synthetic human representations; and
optimizing the intermediate latent space based on the reconstruction losses.

5. The computer-implemented method of claim 4, wherein fine-tuning the parameters of the generator comprises:
performing a second number of iterations using the DHFM to determine a second set of training synthetic human representations;
determining a second set of reconstruction losses for each of the second number of iterations based on the second set of training synthetic human representations; and
updating the parameters of the generator based on the second set of reconstruction losses.

6. The computer-implemented method of claim 1, wherein the one or more inputs further comprises second pose information indicating a second 3D pose representation of a second human,
wherein processing the one or more inputs using the mapping network to generate the intermediate latent code comprises processing the one or more inputs using the mapping network to generate a first intermediate latent code for the pose information indicating the 3D pose representation of the human and a second intermediate latent code for the second pose information indicating the second 3D pose representation of the second human, and
wherein generating the synthetic human representation of the human comprises generating a plurality of synthetic human representations of the human based on the first intermediate latent code and the second intermediate latent code.

7. The computer-implemented method of claim 6, further comprising:
interpolating between the first intermediate latent code and the second intermediate latent code to determine a plurality of intermediate latent codes, wherein the plurality of intermediate latent codes comprises the first intermediate latent code, the second intermediate latent code, and one or more interpolated intermediate latent codes, and wherein the plurality of synthetic human representations that are generated comprises a first synthetic human representation associated with the first intermediate latent code, a second synthetic human representation associated with the second intermediate latent code, and one or more interpolated synthetic human representations associated with the one or more interpolated intermediate latent codes.

8. The computer-implemented method of claim 7, wherein interpolating between the first intermediate latent code and the second intermediate latent code to determine the plurality of intermediate latent codes comprises:
linearly interpolating between the first intermediate latent code and the second intermediate latent code to determine the one or more interpolated intermediate latent codes.

9. The computer-implemented method of claim 1, further comprising:
obtaining appearance editing input indicating one or more modifications for the synthetic human representation, and wherein performing the linear blend skinning and deformation on the texel-aligned Gaussian maps to obtain the modified texel-aligned Gaussian maps comprises:
compositing textures from the appearance editing input with the texel-aligned Gaussian maps to obtain composite texel-aligned Gaussian maps; and
performing the linear blend skinning and deformation on the texel-aligned Gaussian maps on the composite texel-aligned Gaussian maps to obtain the modified texel-aligned Gaussian maps.

10. The computer-implemented method of claim 1, wherein at least one of the steps of obtaining, processing, and performing are performed on a server or in a data center to generate the synthetic human representation, and the synthetic human representation is streamed to a user device.

11. The computer-implemented method of claim 1, wherein at least one of the steps of obtaining, processing, and performing are performed within a cloud computing environment.

12. The computer-implemented method of claim 1, wherein at least one of the steps of obtaining, processing, and performing are performed for training, testing, or certifying a neural network employed in a machine, robot, or autonomous vehicle.

13. The computer-implemented method of claim 1, wherein at least one of the steps of obtaining, processing, and performing are performed on a virtual machine comprising a portion of a graphics processing unit.

14. A system for using a digital human foundational model (DHFM) comprising a generative adversarial network (GAN) generator, comprising:
one or more processors; and
a non-transitory computer-readable medium having processor-executable instructions stored thereon, wherein the processor-executable instructions, when executed by the one or more processors, facilitate:
obtaining one or more inputs comprising pose information indicating a three-dimensional (3D) pose representation of a human;
processing the one or more inputs using a mapping network to generate intermediate latent code;
processing the intermediate latent code using the trained generator to generate texel-aligned Gaussian maps that align Gaussian attributes to a coarse mesh template of the human;
performing linear blend skinning and deformation on the texel-aligned Gaussian maps to obtain modified texel-aligned Gaussian maps;
processing the modified texel-aligned Gaussian maps using a multi-part renderer to generate a synthetic human representation of the human indicating facial and hand features of the human.

15. The system of claim 14, wherein the processor-executable instructions, when executed by the one or more processors, further facilitate:
prior to processing the one or more inputs using the mapping network and processing the intermediate latent code using the trained generator, training the DHFM comprising the mapping network and the generator using a training dataset.

16. The system of claim 15, wherein the processor-executable instructions, when executed by the one or more processors, further facilitate:
subsequent to training the generator using the training dataset, performing further training of the DHFM, wherein performing further training of the DHFM comprises:
optimizing an intermediate latent space associated with the mapping network during a first phase; and
fine-tuning parameters of the generator during a second phase.

17. The system of claim 16, wherein optimizing the intermediate latent space comprises:
performing a first number of iterations using the DHFM to determine training synthetic human representations;
determining reconstruction losses for each of the first number of iterations based on the training synthetic human representations; and
optimizing the intermediate latent space based on the reconstruction losses.

18. The system of claim 17, wherein fine-tuning the parameters of the generator comprises:
performing a second number of iterations using the DHFM to determine a second set of training synthetic human representations;
determining a second set of reconstruction losses for each of the second number of iterations based on the second set of training synthetic human representations; and
updating the parameters of the generator based on the second set of reconstruction losses.

19. A non-transitory computer-readable medium having processor-executable instructions stored thereon for using a digital human foundational model (DHFM) comprising a generative adversarial network (GAN) generator, wherein the processor-executable instructions, when executed, facilitate:
obtaining one or more inputs comprising pose information indicating a three-dimensional (3D) pose representation of a human;
processing the one or more inputs using a mapping network to generate intermediate latent code;
processing the intermediate latent code using the trained generator to generate texel-aligned Gaussian maps that align Gaussian attributes to a coarse mesh template of the human;
performing linear blend skinning and deformation on the texel-aligned Gaussian maps to obtain modified texel-aligned Gaussian maps;
processing the modified texel-aligned Gaussian maps using a multi-part renderer to generate a synthetic human representation of the human indicating facial and hand features of the human.

20. The non-transitory computer-readable medium of claim 19, wherein the processor-executable instructions, when executed, further facilitate:
prior to processing the one or more inputs using the mapping network and processing the intermediate latent code using the trained generator, training the DHFM comprising the mapping network and the generator using a training dataset.
